(19) United States
(12) Patent Application Publication
(10) Pub. No.: US 2020/0330931 A1
(43) Pub. Date: Oct. 22, 2020

(54) FUNCTIONALIZED SILICON NANOMEMBRANES AND USES THEREOF

(71) Applicant: SiMPore Inc., West Henrietta, NY (US)

(72) Inventors: Jared A. CARTER, Rochester, NY (US); James A. ROUSSIE, Rochester, NY (US)

(21) Appl. No.: 16/959,872

(22) PCT Filed: Jan. 7, 2019
(86) PCT No.: PCT/US2019/012576

§ 371 Date: Jul. 2, 2020

Related U.S. Application Data
(60) Provisional application No. 62/614,232, filed on Jan. 5, 2018.
(60) Provisional application No. 62/710,498, filed on Feb. 16, 2018.

(51) Int. Cl. B01D 67/00; B01L 3/00; C01B 33/02; C07F 7/18; B01D 71/02; B01D 71/46; B01D 71/60; B01D 69/02; B01D 61/02; B01D 61/24

(52) U.S. Cl. CPC B01D 67/0093; B01D 2323/36; C01B 33/02; C07F 7/1892; B01D 71/02; B01D 71/46; B01D 71/60; B01D 69/02; B01D 61/027; B01D 61/243; B01L 2300/0896; B01L 2300/12; B01L 2300/0681; B01D 2325/02; B01D 2325/04; B01L 3/502753

(57) ABSTRACT

Provided are methods using and making functionalized silicon membranes, such as, for example, functionalized silicon nanomembranes. The methods may combine one or more (e.g., two) surface modification processes (e.g., using a combination of aldehydes and silanes). Also described are fluidic devices containing functionalized membranes of the present disclosure and uses thereof. The fluidic devices of the present disclosure include one or more functionalized silicon membrane.

### CROSS REFERENCE TO RELATED APPLICATIONS

This application claims priority to U.S. Provisional Application No. 62/614,232, filed on Jan. 5, 2018, and U.S. Provisional Application No. 62/710,498, filed on Feb. 16, 2018, the disclosures of which are incorporated by reference.

### STATEMENT REGARDING FEDERALLY SPONSORED RESEARCH

This invention was made with government support under contract no. IIP1660177 awarded by the National Science Foundation. The government has certain rights in the invention.

### FIELD OF THE DISCLOSURE

The present disclosure relates to silicon membranes with nano to microscale pores/slits. More particularly, the present disclosure relates to methods of preparing and methods of using silicon membranes with nano to microscale pores/slits.

### BACKGROUND OF THE DISCLOSURE

There is a need for precision filtration membranes bearing functionalization (i.e., surface coatings) in order to improve their utility in an application-specific manner. Such filtration membranes should offer high permeability and well-defined solute permeation characteristics (i.e., a large capacity to permeate specifically sized solutes, while retaining other specifically sized solutes). The functionalization of such membranes should not therefore reduce such solute permeability or selectivity. Further, the functionalization should promote the intended application; e.g., prevent fouling, promote selective solute permeation or retention, etc.

Silicon nanomembranes are one class of such high capacity and selective permeability filtration membranes. However, there is yet no practical, scalable, and industrially manufacturable means for stable (i.e., non-hydrolyzable) functionalization of silicon nanomembranes. Further, no such present functionalization method fulfills the application-specific utility needs nor the need to maintain permeability characteristics. For example, functionalization using only silane chemistries (e.g., to form Si—O—Si bonds) is prone to hydrolysis and removal from the surface due to incomplete surface functionalization. Adventurous molecules are able to approach within van der Waals interaction radii of silanes at low surface density (i.e., incomplete surface functionalization), and thus promote their hydrolysis. Such adventurous molecules may be solution components (H⁺, ⁻OH, or other acids and bases) or other proximal silane molecules. For instance, Meller and Wanunu describe in U.S. Pat. No. 9,121,843 silane-based modifications of porous silicon nitride membranes. However, such silanes lack the requisite hydrolytic stability as is known to those skilled in the art. Therefore, there is a need to improve the density of surface functionalization.

Other possible means for modifying silicon nanomembranes have been described. For example, carbene precursors have been used to modify silicon nitride. However, the light-sensitive nature of carbenes and practical difficulties in obtaining highly purified carbenes makes this process unsuitable for industrial-scale manufacturing. As another example, alkylation-based methods for functionalizing bulk silicon nitride layers have been described. However, the harsh processing conditions associated with such methods makes them unsuitable for freely suspended silicon nanomembranes. As another example, grafted polymer brushes of zwitterionic materials (e.g., sulfobetaine methylacrylate) offer non-fouling surface grafts. However, the harsh free radical processing conditions and the resultant excess thickness of such polymer brushes makes them unsuitable for processing freely suspended silicon nanomembranes and for maintaining the permeability of such membranes.

There is an ongoing and unmet need for methods to better modify silicon nanomembranes.

### SUMMARY OF THE DISCLOSURE

In particular, the present disclosure describes methods for combinations of one or more surface modification processes that may yield highly dense surface monolayers that are not prone to hydrolysis nor significantly reduce membrane permeability. Such combination processes rely on multiple, distinct, and inherent reactive surface groups within silicon membranes, such that distinct chemical processes may be carried out using these one or more distinct surface reactive groups in order to functionalize membranes to a greater extent. Thus, multiple means for modifying silicon membranes may be possible with the methods of the present disclosure, which form the necessary dense surface monolayers that are required for hydrolytic stability. Further, one class of chemical process and functionalization, that yield more hydrolytically stable derivatives, may be used in combination with another class of chemical process and functionalization, that may suffer from hydrolysis, in order to promote the hydrolytic stability of the second class. Such a combination yields an overall higher surface density of functionalized groups, thus reducing attack by adventurous molecules that may displace them.

The present disclosure describes methods and uses of functionalized silicon membranes. In various examples, the methods disclosed herein describe membrane (e.g., nanomembrane) functionalization which may be used to functionalize silicon membranes (e.g., nanomembranes) with industrially scalable processes. In particular, the present disclosure describes methods for combinations of one or more surface modification processes that can yield highly dense surface monolayers that are not prone to hydrolysis nor significantly reduce membrane (e.g., nanomembrane) permeability.

In an aspect, the present disclosure provides functionalized silicon membranes. The functionalized silicon membranes (e.g., nanomembrane) are stable (i.e., non-hydrolyzable). In various examples, a functionalized silicon membrane (e.g., nanomembrane) is made by a method of the present disclosure.

In an aspect, the present disclosure provides methods of functionalizing a silicon membrane (e.g., nanomembrane). The methods are based on reaction of a reactive surface group on a surface of silicon nanomembrane (i.e., a substrate surface group) with a functional group on a functionalizing group precursor compound. In various examples, the methods can improve the hydrolytic stability of present (e.g., silane-based), as well as other, functionalization methodologies.

In an aspect, the present disclosure describes fluidic devices incorporating at least one functionalized silicon membrane (e.g., nanomembrane) and uses of such fluidic devices. For example, a fluidic device is used for filtration applications or methods.

### BRIEF DESCRIPTION OF THE FIGURES

For a fuller understanding of the nature and objects of the disclosure, reference should be made to the following detailed description taken in conjunction with the accompanying figures.

FIG. 1 shows a two-step reaction mechanism which demonstrates covalent modification via a classical silane condensation reaction onto silicon-rich SiN via selective modification of silicon oxide terminal groups. “Reaction A” characterizes the bulk deposition of an amine-reactive (isocyanate functional group) trialkoxy silane onto previously oxidized silicon nitride. In this mechanism the terminal silicon atoms are oxidized, and provide a surface reactive to the silane via dehydration of the alkoxy leaving group (in this instance ethanol). “Reaction B” demonstrates the subsequent modification of the surface by an any primary amine containing species yield a stable urea linker mechanism under a variety of reaction conditions (though favored under slightly basic conditions)

FIG. 2 shows a gaseous phase derivatization of previously oxidized Si-rich SiN surfaces using epihalohydrin as a surface linker yielding a terminal epoxide group. “Reaction A” demonstrates the covalent decoration of SiOH group on the SiN surface by epichlorohydrin which reacts via a ring-opening reaction of the epoxide, followed by the reformation of the epoxide ring by subsequent dehalogenation under vacuum. “Reaction B” demonstrates the subsequent modification of the surface by an any primary amine containing species yield a stable urea linker mechanism under a variety of reaction conditions

FIG. 3 shows sessile water contact angle data for films prepared using the reaction mechanisms detailed in FIG. 1 (silane-based chemistry) and FIG. 2 (epoxidation-based chemistry). Films of both varieties were either further reacted with a purified protein (bovine serum albumin), a non-fouling group (ethanolamine), or unchanged (native). In the native condition, water contact angles collected demonstrate a significant increase in surface hydrophobicity consistent with the decoration of carbon-rich surface groups. Wetting angles decrease considerably with subsequent treatment via both a protein and ethanolamine, consistent with the increase in hydrophilic species on the underlying films.

FIG. 4 shows fluorescent labeling of the various surfaces further derivatized in FIG. 3 via fluorescein isocyanate under basic aqueous conditions. Fluorescent labeling of each surface type confirms the presence of the primary amine-rich purified protein (BSA) and no labeling of the native or ethanolamine-treated surface (consistent with the predicted surface composition of all films).

FIG. 5 shows structures of the surface derivatizing chemistries used in Example 1, including an isocyante-functional silane (3-(triethoxysilyl)-propyl isocyanate), epoxidation reagent (epichlorohydrin), and a terminal non-fouling group (ethanolamine).

FIG. 6 shows a basic system for the gaseous-phase covalent modification of previously-oxidized silicon nitride membranes. The system is generally composite of a vacuum pump, a chemical trap (filled with molecular sieves to getter waste reaction products and unreacted chemistry), a deposition chamber, a system vent to atmosphere, a chemistry flask, and a pressure monitor. A series of valves allows the isolation of each system element to control the flow of gases through the deposition chamber.

FIG. 7 shows a detail of the deposition system shown in FIG. 6, which shows the perforated polypropylene sample tray, elevated to promote gaseous chemistry flow across and through the SiN membranes. The chamber dome itself is sealed with a perimeter gasket and may be accessed by two valve ports for vacuum and chemistry access to the chamber.

FIG. 8 shows relative protein adsorption to various Silicon Nitride films in either a native state, Pre-cleaned with piranha, or ethanolamine coated using the reaction chemistry described in FIG. 2. All films evaluated were exposed to solutions of dilute (10% in PBS), neat adult bovine serum, or 1% serum albumin in PBS for 24 hours at room temperature. Nonspecifically adsorbed protein films were fluorescently labeled using FITC under slightly basic aqueous conditions, then background corrected against non-protein exposed control SiN membranes. These data demonstrate surface functionalization and termination with ethanolamine increases repulsion of protein species likely by maintaining a neutral surface charge and tightly bonded water layer at the surface interface.

FIG. 9 shows relative surface fouling by a fluorescently labeled bovine serum albumin solution. Image (A) and (B) show fluorescent microscopy (4× magnification) of NPN nanomembrane films untreated and treated with the ethanolamine surface chemistry respectively. Image (C) shows the quantitative whole-field mean fluorescent intensity of both fields shown in (A, B).

FIG. 10 shows surface adhesion of cells to nanomembrane surfaces with surface chemistry modified by the methods of the present disclosure. The extent of blood-derived cellular adhesion was compared between ethanolamine and untreated silicon nanomembranes.

FIG. 11 shows a tangential flow-based fluidic device for incorporating nanomembrane filters. A prototype Fluidic Module with polycarbonate fluidic channels in the body and elastomeric gaskets for filter integration was fabricated by 3D-printing. CAD modeling software was used to render a prototype device (A) suitable for multi-material 3D-printing (B-C). Computational fluid dynamics analysis was performed on the design to verify surface velocities (D), system pressure (E) and sheer stress (F) to ensure such exemplary prototypes would be suitable fluidic devices for the methods of the present disclosure.

FIG. 12 shows a representative fluidic device incorporating a nanomembrane filter, wherein the nanomembrane filter is integrated into a centrifuge tube insert fluidic device for dead-end (normal) flow filtration purposes. (A, B, C, D, E, and F) show representative filter devices incorporating silicon nitride membranes that may employ one or more non-fouling coatings as previously described. (H) shows a series of representative nanomembranes fabricated using similar fabrication processes.

FIG. 13 shows images taken via Electron Microscopy of a range of Silicon Nitride membranes. (A) shows a 400 nm thick microporous SiN membrane of 25.9% porosity decorated with 8.2-micron diameter pores at regular intervals. (B) shows a 400 nm thick microslit membrane of 26.8% porosity with 3.5-micron wide slits. (C) shows a 200 nm thick SiN membrane of 27.2% porosity and 282 nm pores at regular intervals. Finally, (D) shows a 400 nm SiN membrane of 6.2% porosity comprised of 454 nm wide slits.

FIG. 14 shows a further image study of micropores as evaluated by electron microscopy. (A) Shows a 400 nm thick SiN membrane of 22.1% porosity containing 2.8-micron diameter pores. (B) Shows a 400 nm thick SiN membrane of 10.5% porosity containing 682 nm diameter pores. (C) Shows a 400 nm thick SiN membrane of 25.5% porosity containing 552 nm diameter pores.

FIG. 15 shows a series of nanoporous nitride membranes fabricated using a range of membrane thicknesses, pore diameters, and porosities. (A, B) Show a series of 100 nm thick membranes decorated with either 51 nm pores and 13.9% porosity, or 56.5 nm pores and 16.5% porosity respectively. Images (C-F) show a series of nanomembranes of 50 nm nominal thickness decorated with a range of pore diameters and porosities as follows [C; 83 nm pores, 23.4% porosity. D; 42.8 nm pores, 6% porosity. E; 33.4 nm pores, 6.3% porosity. F; 46.7 nm pores, 31.9% porosity].

FIG. 16 shows a schematic representation a fluidic device comprising a silicon membrane (e.g., nanomembrane) of the present disclosure. The figures shows fluidic channels/chambers (100); membrane surfaces (101); a porous membrane (102); apertures (103); and a substrate (104).

### DETAILED DESCRIPTION OF THE DISCLOSURE

Although the disclosed subject matter will be described in terms of certain embodiments, other embodiments, including embodiments that do not provide all of the benefits and features set forth herein, are also within the scope of this disclosure. Various structural, logical, and process step changes may be made without departing from the scope of the disclosure.

Ranges of values are disclosed herein. The ranges set out a lower limit value and an upper limit value. Unless otherwise stated, the ranges include all values to the magnitude of the smallest value (either lower limit value or upper limit value) and ranges between the values of the stated range.

The present disclosure describes methods for functionalization of silicon membranes. The present disclosure further describes functionalized silicon membranes and uses thereof.

As used herein, unless otherwise stated, the term “group” refers to a chemical entity that has one terminus or two or more termini that can be covalently bonded to other chemical species. Examples of groups include, but are not limited to:

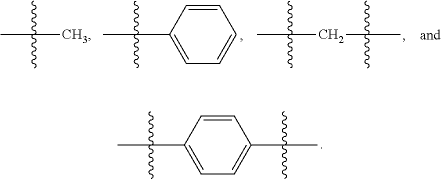

The term “group” includes radicals.

As used herein, unless otherwise indicated, the term “aliphatic” refers to branched or unbranched hydrocarbon groups that, optionally, contain one or more degrees of unsaturation. Degrees of unsaturation include, but are not limited to, alkenyl groups/moieties, alkynyl groups/moieties, and cyclic aliphatic groups/moieties. For example, the aliphatic group can be a C₁ to C₁₈ aliphatic group, including all integer numbers of carbons and ranges of numbers of carbons therebetween. The aliphatic group can be unsubstituted or substituted with one or more substituent. Examples of substituents include, but are not limited to, various substituents such as, for example, halogens (—F, —Cl, —Br, and —I), additional aliphatic groups (e.g., alkenes, alkynes), aryl groups, alkoxides, carboxylates, carboxylic acids, ether groups, silane groups, amine groups, thiol/sulfhydryl groups, isothiocyanate groups, epoxide groups, maleimide groups, succinimidyl groups, anhydride groups, mercaptan groups, hydrazine groups, N-glycan groups, O-glycan groups, and the like, and combinations thereof.

As used herein, unless otherwise indicated, the term “alkyl” refers to branched or unbranched saturated hydrocarbon groups. Examples of alkyl groups include, but are not limited to, methyl groups, ethyl groups, propyl groups, butyl groups, isopropyl groups, tert-butyl groups, and the like. For example, the alkyl group can be a C₁ to C₁₈ alkyl group, including all integer numbers of carbons and ranges of numbers of carbons therebetween,. The alkyl group can be unsubstituted or substituted with one or more substituent. Examples of substituents include, but are not limited to, various substituents such as, for example, halogens (—F, —Cl, —Br, and —I), aliphatic groups (e.g., alkyl groups, alkenyl groups, alkynyl groups), aryl groups, alkoxide groups, carboxylate groups, carboxylic acids, ether groups, silane groups, amine groups, thiol/sulfhydryl groups, isothiocyanate groups, epoxide groups, maleimide groups, succinimidyl groups, anhydride groups, mercaptan groups, hydrazine groups, N-glycan groups, O-glycan groups, and the like, and combinations thereof.

In particular, the present disclosure describes methods for combinations of one or more surface modification processes that may yield highly dense surface monolayers that are not prone to hydrolysis nor significantly reduce membrane permeability. Such combination processes rely on multiple, distinct, and inherent reactive surface groups within silicon membranes, such that distinct chemical processes may be carried out using these one or more distinct surface reactive groups in order to functionalize membranes to a greater extent. Thus, multiple means for modifying silicon membranes may be possible with the methods of the present disclosure, which form the necessary dense surface monolayers that are required for hydrolytic stability. Further, one class of chemical process and functionalization, that yield more hydrolytically stable derivatives, may be used in combination with another class of chemical process and functionalization, that may suffer from hydrolysis, in order to promote the hydrolytic stability of the second class. Such a combination yields an overall higher surface density of functionalized groups, thus reducing attack by adventurous molecules that may displace them.

The present disclosure describes methods and uses of functionalized silicon membranes. In various examples, the methods disclosed herein describe membrane (e.g., nanomembrane) functionalization, which may be used to functionalize silicon membranes (e.g., nanomembranes) with industrially scalable processes. In particular, the present disclosure describes methods for combinations of one or more surface modification processes that can yield highly dense surface monolayers that are not prone to hydrolysis nor significantly reduce membrane (e.g., nanomembrane) permeability.

In an aspect, the present disclosure provides functionalized silicon membranes. The functionalized silicon membranes (e.g., nanomembrane) are stable (i.e., non-hydrolyzable). In various examples, a functionalized silicon membrane (e.g., nanomembrane) is made by a method of the present disclosure. A silicon membrane may be referred to as a nanomembrane and may comprise a plurality of nanopores, micropores, or microslits, where a plurality of nanopores, micropores, or microslits may fluidically connect one or more membrane surface to an opposing one or more membrane surface and, optionally, at least one aperture.

Description of silicon membranes (e.g., nanomembranes) may also refer to description of functionalized silicon membranes (e.g., nanomembranes) and the term silicon membrane may be used when referring to functionalized silicon membrane (e.g., nanomembrane), including singular and plural forms.

A functionalized silicon membrane (e.g., nanomembrane) has a plurality of functionalizing groups disposed on at least a portion of a surface of a silicon membrane (e.g., nanomembrane). The groups comprise one or more terminal functional groups. The functionalized silicon membranes (e.g., nanomembranes) with one or more terminal functional groups exhibit one or more desirable properties. Without intending to be bound by any particular theory, it is considered that the terminal functional groups provide one or more desirable properties of a functionalized silicon membrane (e.g., nanomembrane).

The terminal functionalizing groups can be covalently bonded directly to a surface of a functionalized silicon membrane (e.g., nanomembrane) or covalently bonded to a surface of a functionalized silicon membrane (e.g., nanomembrane) via one or more linking groups. For the purposes of this disclosure, the terms terminal group, terminal group forming compound, and terminal moiety (in both singular and plural forms) are used synonymously. Terminal groups are not passively coated (e.g., physisorbed and/or chemisorbed) on the silicon membrane (e.g., nanomembrane).

The functionalization (e.g., individual functionalizing groups) is of appropriate atomic length and molecular size such that it does not significantly reduce the permeability of silicon membranes (e.g., nanomembranes). For example, a nanoporous silicon nitride membrane comprises a mean pore diameter of 50 nm. Functionalization of such a membrane (e.g., nanomembrane) with, for example, a three-carbon, five-carbon, or twenty-carbon alkane reduces mean pore diameter by 0.92 nm, 1.5 nm, and 6.2 nm, respectively. In the former two examples, the reduction in mean pore size will not significantly reduce permeability. However, the latter example will significantly reduce permeability (due to a greater than 10% reduction in mean pore diameter). In various examples, the functionalization does not reduce the mean of the longest pore dimension parallel to the longest axis of the pore (e.g., mean pore diameter) of at least a portion of the silicon membrane (e.g., nanomembrane) pores by greater than 10%, greater than 15%, or greater than 20%. Thus, it is desirable that the functionalization of silicon membranes (e.g., nanomembranes) be of limited atomic length and molecular size in order to prevent a decrease in membrane (e.g., nanomembrane) permeability. For the purposes of this disclosure, a significant reduction in permeability should be considered one that reduces mean pore size by more than 20%.

For purposes of this disclosure, surface density should be considered the number of, for example, surface reactive groups or resultant surface groups on silicon membranes (e.g., nanomembranes) that are covalently bonded to a silicon membrane (e.g., nanomembrane) surface, and thus, should be considered the extent of silicon membrane (e.g., nanomembrane) covered by such groups (i.e., surface coverage extent). The multiple, distinct reactive surface groups may be functionalized using one or more individual chemical processes that form covalently bonded linker and/or terminal groups on silicon membranes (e.g., nanomembranes). Surface density should be empirically determined buy one of the several metrology methods disclosed herein.

In an example, the surface coverage extent of functionalized surface density of reactive hydroxyl surface groups is 100% (i.e., such groups comprise complete reaction with either the epoxide or the silane functionalization methods described herein). As another example, the surface coverage extent of functionalized surface density of reactive amine surface groups is 100% (i.e., such groups comprise complete reaction with the aldehyde functionalization methods described herein). As another example, the surface coverage extent of functionalized surface density of reactive hydroxyl surface groups is 100% and the surface coverage extent of functionalized surface density of reactive amine surface groups is 100% (i.e., the hydroxyl groups comprise complete reaction with the silane functionalization methods described herein and the amine groups comprises complete reaction with the aldehyde functionalization methods described herein). Without intending to be bound by any particular theory, the extent of chemical activation of surface reactive groups, time, temperature, and concentration of epoxide, silane, and aldehyde reactants may all affect the extent of functionalization surface density. In various examples, the surface coverage extent of functionalized surface density of reactive surface groups (e.g., hydroxyl surface groups, amine groups, silane groups, and the like) is 95, 96, 97, 98, 99, 99.5, 99.9%. In various examples, the surface coverage extent of functionalized surface density is 20% to 100%, including all 0.1% values and ranges therebetween. In another example, the surface coverage extent of functionalized surface density is 40% to 80%, including all 0.1% values and ranges therebetween, where such a range provides a useful surface coverage extent. By “useful surface coverage extent,” it is meant that the range of surface coverage forms a biomolecule, non-fouling, and/or surface property modifying functionalized membrane for the uses disclosed herein. Examples of such uses may include, but are not limited to, hemodialysis, routine separations, or sterile filtration.

The functionalization is stable in hydrolytic environments. For example, high (e.g., ≥8) or low (e.g., ≤6) pH, high salt (e.g., ≥500 mM total salt), elevated temperature (e.g., ≥37° C.), and/or prolonged exposure duration may all promote hydrolysis of functional groups used to derivatize silicon membranes (e.g., nanomembranes). In examples disclosed herein, amine bonds (i.e., C—N bonds) are preferred due to their increased hydrolytic stability over silane bonds (i.e., Si—O—Si bonds). In further examples disclosed herein, amide-based derivatization of silicon membranes (e.g., nanomembranes) is combined with silane-based derivatization of silicon membranes (e.g., nanomembranes), such that the combination increases the density and surface coverage, and thus, promotes the hydrolytic stability of both functional derivatives. In an example disclosed herein, the functionalized silicon membranes (e.g., nanomembranes) are used for hemodialysis and the required hydrolytic stability is from several hours (e.g., ≥3 hours) to multiple days (e.g., ≥2 days). In another example disclosed herein, the functionalized silicon membranes (e.g., nanomembranes) are used for routine separations and the required hydrolytic stability is from several hours (e.g., ≥2 hours) to multiple days (e.g., ≥1 day). In another example disclosed herein, the functionalized silicon membranes (e.g., nanomembranes) are used for sterile filtration and the required hydrolytic stability is from several hours (e.g., ≥2 hours) to multiple days (e.g., ≥1 day).

For purposes of this disclosure, hydrolytic stability, hydrolytically stable, and non-hydrolyzable should be considered synonymous terms. Such terms refer to the extent of surface modification coverage that resists hydrolysis for the exemplary time-courses described herein. By “resistance” and “stability,” it is meant that the extent of surface coverage is unchanged (i.e., no detectable loss of covalently bonded groups) when comparing modified membranes (e.g., nanomembranes) exposed to hydrolytic conditions versus similarly modified membranes (e.g., nanomembranes) not exposed to hydrolyzing conditions, wherein the comparison to determine changes in extent of surface coverage is performed by one or more of the metrology techniques disclosed herein.

The silicon membranes (e.g., nanomembranes) may be nanoporous, microporous, or microslit membranes. For porous or slit membranes (e.g., nanomembranes), it is desirable that the addition of surface functionalization be of appropriate atomic length so as to not significantly reduce pore or width sizes, porosity, and/or permeability. Further, it is desirable that such surface functionalization exhibits practically no rate of hydrolysis (i.e., comprises covalently stable bonds) within a wide range of chemical and solution environments. In an example, the surface functionalization exhibits no observable rate of hydrolysis (i.e., comprises covalently stable bonds). The rate of hydrolysis can be determined by methods known in the art. For example, the rate of hydrolysis is determined by a metrology method disclosed herein.

In an example, the silicon membrane (e.g., nanomembrane) is a nanoporous silicon nitride membrane (NPN). Examples of NPN membranes and the fabrication of such membranes are disclosed in U.S. Pat. No. 9,789,239 (Striemer et al. “Nanoporous Silicon Nitride Membranes, and Methods for Making and Using Such Membranes”), the disclosure of which with regard to NPN membranes is incorporated herein by reference.

In another example, the silicon membrane (e.g., nanomembrane) is a microporous silicon nitride membrane (MP SiN). Examples of MP SiN membranes and the fabrication of such membranes are known in the related art.

In yet another example, the silicon membrane (e.g., nanomembrane) is a microslit silicon nitride membrane (MS SiN). Examples of MS SiN membranes and the fabrication of such membranes are disclosed in U.S. Application No. 62/546,299 (Roussie et al. “Devices, Methods, and Kits for Isolation and Detection of Analytes Using Microslit Filters”), the disclosure of which with regard to NPN membranes is incorporated herein by reference.

In yet another example, the silicon membrane (e.g., nanomembrane) is a microporous flat tensile silicon oxide membrane (MP SiO₂). Examples of MP SiO₂ membranes and the fabrication of such membranes are disclosed in U.S. Pat. No. 9,945,030 (Striemer et al. “Free-Standing Silicon Oxide Membranes, and Methods of Making and Using Same”), the disclosure of which with regard to MP SiO₂ membranes is incorporated herein by reference.

Silicon membranes (e.g., nanomembranes) can be chips or dies. In various examples, the silicon membrane (e.g., nanomembrane) structure is a chip or die, where the chip or die is derived from a portion of or the entirety of a silicon wafer substrate. The structures can be monolithic structures, where the chip or die comprises at least one functionalized silicon membrane disposed on a portion or all of the silicon wafer substrate. The membrane comprises a plurality of surfaces (e.g., a first membrane surface, second membrane surface, etc.), one or more aperture, and a plurality of nanopores, micropores, or microslits within the silicon membrane (e.g., nanomembrane). For purposes of this disclosure, the terms substrate, chip, or die refer to silicon membranes (e.g., nanomembranes). One or more of these structures, chips, or dies may be incorporated into fluidic devices of the present disclosure.

In the various examples, the silicon membranes (e.g., nanomembranes) have a nanopore, a micropore, or a microslit density of 10² to 10¹⁰ pores/mm², including all integer pores/mm² values and ranges therebetween. In the various examples, the silicon membranes (e.g., nanomembranes) have a nanopore or a micropore diameter, or a microslit width of 11 nm to 10 μm, including all integer nm values and ranges therebetween. For NPN membranes, the mean nanopore diameter is, for example, at least 11 nm. The nanopore or a micropore diameter, or the microslit width, is not ≤10 nm. The porous or slit layer is disposed on a silicon wafer substrate of <100> or <110> crystal orientation. Further, one or more aperture extends through the thickness of the silicon wafer, such that a plurality of membrane surfaces are formed (e.g., a first membrane surface and a second (i.e., opposing) membrane surface) by the one or more aperture, and the plurality of nanopores, micropores, or microslits, are fluidically connected to the one or more aperture. The aperture surface comprises internal sidewalls within the substrate. The plurality of nanopores, micropores, microslits, and apertures all contribute to the surface area of the membrane chip or die. The aperture of the substrate can be formed by standard photolithographic patterning, reactive ion etching of a masking layer, wet chemical through-substrate etching, and other methods known to those skilled in the art. Through-substrate etching forms apertures connected with each first and each second membrane surface (i.e., formed by the one or more aperture) and the plurality of nanopores, micropores, or microslits, are fluidically connected to the one or more aperture.

In various examples, an aperture extends through the thickness of the silicon substrate such that a first membrane surface is formed by the aperture, and at least some of the plurality of nanopores, micropores, or microslits are fluidically connected to the aperture at the first membrane surface. In additional examples, one or more additional apertures extend through the thickness of the silicon substrate such that a corresponding one or more additional membrane surfaces are formed by the one or more aperture.

The silicon membranes (e.g., nanomembranes) can have a range of membrane thickness. In various examples, the nanoporous, microporous, or microslit membrane (e.g., nanomembrane) have a thickness of 20 nm to 10 μm, including all integer nm values and ranges therebetween.

In an example, an aperture has a longest dimension (e.g., a diameter) greater than or equal to 50 μm. In another example, an aperture has a longest dimension (e.g., diameter) of greater than or equal to 100 μm. In various examples, apertures can have dimensions of 100 μm by 100 μm, of 1 mm by 1 mm, of 1 mm by 10's of mm, or the like.

The functionalization can comprise various functionalizing groups. In an example, all of the functionalizing groups are the same. In another example, a functionalized silicon membrane (e.g., nanomembrane) comprises a combination of at least two different functionalizing groups. In various examples, the functionalized silicon membrane (e.g., nanomembrane) comprises two or more selectively functionalized membrane surfaces, one or more selectively functionalized aperture, one or more selectively functionalized intra-pore or intra-slit surface, and/or a combination thereof.

The functionalization may be non-fouling groups and/or surface property modifying groups. Examples of functionalizing groups are described herein. Such groups may be referred to as terminal forming compounds.

In an aspect, the present disclosure provides methods of functionalizing a silicon membrane (e.g., nanomembrane). The methods are based on reaction of a reactive surface group on a surface of silicon nanomembrane (i.e., a substrate surface group) with a functional group on a functionalizing group precursor compound. In various examples, the methods can improve the hydrolytic stability of present (e.g., silane-based), as well as other, functionalization methodologies.

In various examples, the disclosure describes covalent reaction chemistries for the modification of silicon membranes (e.g., nanomembranes). The functionalization may be non-fouling groups and/or surface property modifying groups. The functionalization may also be referred to as modification or as derivatization.

In an example, the methods disclosed herein for functionalizing silicon membranes (e.g., nanomembranes) comprise one or more selective chemistries which react with unique classes of functional groups of the silicon membranes (e.g., nanomembranes) (e.g., substrate surface groups). Thus, one selective chemistry may be used to functionalize a first substrate surface group, while a second selective chemistry may be used to functionalize a second substrate functional group, and the one or more selective chemistries may comprise distinct bonds linking to the silicon membrane (e.g., nanomembrane) substrate. For example, epoxidation or silanization is used to react with substrate surface hydroxyl groups to form Si—O—C or Si—O—Si bonds, respectively. As another example, aldehylation followed by reductive amination, is used to react with substrate surface amine groups to form Si—N—C bonds. In such examples, the first instance of “Si” refers to the Si of the silicon membrane (e.g., nanomembrane), the second instance of “O” or “N” refers to the atom derived from the substrate surface group, and the final instance of “C” or “Si” refers to the atom of the derivatizing molecule.

In various examples, functionalization methods disclosed herein are combined such that a greater extent of surface coverage and surface functionalization is achieved in comparison to use of only one functionalization method. Further, the combined functionalization may rely on amide bonds (which are less prone to hydrolysis) to protect silane bonds (which are more prone to hydrolysis). Thus, the amide bonds may provide a means for greater surface functionalization that can overcome the well-known problem of incomplete surface coverage of silanes (which promotes their hydrolysis and removal from the substrate surface).

In various examples, a method for the functionalization of silicon membranes (e.g., nanomembranes) using covalent reaction chemistries comprises activation or treatment of the membrane surface by solution-phase chemistries, such that reactive surface groups are formed (e.g., substrate surface hydroxyl or amine groups). Such substrate surface groups may be further reacted with a first molecule comprising at least one first reactive group that selectively reacts with substrate surface groups. Examples of such first molecules include, but are not limited to, epihalohydrins, aldehydes, and/or silanes, and the like. The first molecules may further comprise at least one second reactive group for further derivatization with one or more second molecules. These second molecules may include terminal groups (e.g., a non-fouling group, a surface modifying group, or combinations thereof). Alternatively, the first molecules may be cross-linked or covalently reacted to one another, and thus comprise at least two or more reactive groups for such cross-linking. Alternatively, the first molecules may comprise a first reactive group that reacts with substrate surface groups and one or more terminal groups as disclosed herein (i.e., intrinsic terminal groups). Alternatively, the second molecules may comprise a spacer of varying length (e.g., C₁-C₁₈ aliphatic groups, such as, but not limited to, alkyl groups), a first reactive group that reacts with the first molecule's reactive group, and at least one or more second reactive group that can react with any terminal group and/or can cross-link to any other second molecules.

Means for bonding first molecules (e.g., first compound) to terminal groups, first molecules (e.g., first compounds) to second molecules (e.g., second compounds), second molecules (e.g., second compounds) to terminal groups, cross-linking first molecules (e.g., first compounds) to first molecules (e.g., first compounds), and/or cross-linking second molecules (e.g., second compounds) to second molecules (e.g., second compounds) include substitution reactions (e.g., nucleophilic attack where a group (e.g., a halogen or other suitable leaving group) is displaced), click reactions (i.e., a 3+2 reaction between an azide moiety and alkynyl moiety), other reactions between a nucleophile (e.g., an amine, a thiol, an alkoxide, and the like) and electrophile (e.g., a maleimide, anhydride, epoxide, and the like), cross-coupling reactions (e.g., a Heck reaction and the like), and other strategies known in the art. For example, spacer groups are present between first molecules (e.g., first compounds) and terminal groups. In such an example, the spacer group (e.g., spacer compound) is covalently bonded to the first molecule (e.g., first compound) using methods described herein or known in the art, and the terminal group is covalently bonded to the spacer molecule (e.g., spacer compound) also using methods described herein or known in the art. Non-limiting examples of functional groups and or reaction partners include silane, amino, carboxyl, thiol/sulfhydryl, isothiocyanate, epoxide, iodo-, alkane, maleimide, succinimidyl, anhydride, mercaptan, hydrazine, N-glycan, or O-glycan, and the like. In an example, these groups are used for bonding first molecules (e.g., first compounds) to terminal groups, first molecules (e.g., first compounds) to spacer molecules (e.g., spacer compounds), spacer molecules (e.g., spacer compounds) to terminal groups, cross-linking first molecules (e.g., first compounds) to first molecules (e.g., first compounds), and/or cross-linking spacer molecules (e.g., spacer compounds) to spacer molecules (e.g., spacer compounds).

For purposes of this disclosure, the terms “spacer molecule,” “spacer compound,” and “linker” molecules (i.e., second molecules) are used synonymously.

For the purposes of this disclosure, the terms “terminal groups” or “terminal moieties” can refer to such groups that are derived from listed examples. For example, where ethanolamine is referred to as a terminal group, the terminal group can also be referred to as an ethoxyaminyl group or an aminoethoxyl group. Additionally, “terminal group” or “terminal moiety” is synonymous with “terminal moiety forming molecule.”

In various examples, the functionalization of silicon membranes (e.g., nanomembranes) modifies the membrane (e.g., nanomembrane) surface properties for particular applications. For example, the terminal group is a group that promotes non-fouling of the membrane by maintaining a hydration layer (e.g., hydroxyl groups or zwitterionic groups) or by a hydrophobic surface (e.g., perfluorinated groups), wherein either terminal groups prevent non-specific absorption of molecules or blood components. Further, the chemical properties of the hydration layer may reduce surface tension, thus promoting the wetting ability of functionalized membranes.

As an example of functionalization of a silicon membrane (e.g., nanomembrane) with a non-fouling terminal group, a membrane (e.g., nanomembrane) is chemically oxidized, reacted with epichlorohydrin, and then reacted with ethanolamine to provide a functionalized silicon membrane (e.g., nanomembrane). As another example, a membrane (e.g., nanomembrane) is chemically oxidized, reacted with epichlorohydrin, and then reacted with amine-polyethyleneglycol (PEG) to provide a functionalized silicon membrane (e.g., nanomembrane). As another example, a membrane (e.g., nanomembrane) is hydrofluoric acid (HF) treated and then reacted with glyceraldehyde to provide a functionalized silicon membrane (e.g., nanomembrane). As another example, a membrane (e.g., nanomembrane) is HF treated, reacted with glutaraldehyde, and then reacted with ethanolamine to provide a functionalized silicon membrane (e.g., nanomembrane). In all such examples, the terminal group comprises one or more hydroxyl groups. In these examples, use of any required acid/base catalyst or reductive amination agent is assumed. Of course, many other examples are possible.

In an example, the non-fouling group has a range of linear or branched groups. Such linear or branch groups (e.g., aliphatic groups) are homogenous (e.g., containing only carbon and hydrogen) or heterogeneous (e.g., containing carbon, hydrogen, and other heteroatoms (e.g., oxygen, sulfur, nitrogen, and the like)) in composition and structural arrangement, and comprises, for example, one or more linear or branch chains (e.g., aliphatic chains). Further, such non-fouling groups may be terminated or substituted with one or more functional groups that endow non-fouling properties (e.g., hydroxyl groups, zwitterions, hydrophobic, and the like) and should not decrease mean pore diameter or slit width by more than 10% (i.e., for every 50 nm of pore diameter or slit width, the linear or branched aliphatic (e.g., alkyl) chains should be less than 20 carbons in length). Non-limiting examples of non-fouling groups include ethanolamine, ethylene and polyethylene glycols and co-polymers thereof, vinyl alcohols or pyridines and polymers thereof, perfluorinated or other terminal fluorine presenting groups and polymers thereof, and the like. Additional non-limiting examples of non-fouling groups include sulfobetaine and analogs and derivatives thereof, Fmoc-lysine, hydroxylamine-O-sulfonic acid, 3-(amidinothio)-1-propanesulfonic acid, 6-carbon to 8-carbon long terminal aldehydes with heavily fluorinated aliphatic (e.g., alkyl) chains, or perfluorooctanesulfonamide. Fmoc-lysine comprises a fluorenylmethyloxycarbonyl (i.e., Fmoc) protective group at the C1 (alpha) position amine such that reaction to the modified reactive surface groups may occur at the C5 (epsilon) amine group of lysine (e.g., Fmoc subsequently deprotected in N, N-dimethylformamide with piperidine). Another example zwitterionic terminal group may be H₂N-Lys-Glu-Lys-CO₂H tripeptide (where the C5 (epsilon) lysine side-chains and C-terminus are functionalized with protecting groups) as a larger zwitterion and hydrogen bonding moiety.

In an example, the non-fouling coating prevents surface adsorption of interfering species via a gradual release of the one or more compounds (e.g. anticoagulants such as sodium heparin or citrate, and the like) by, for example, selective degradation of the film or structural rearrangement of the film to achieve dissipation of incorporated species by one or more mechanisms (e.g. dissolution, depolymerization, temperature or pH-induced structural changes, or other mechanisms).

For purposes of this disclosure, the functionalization of membranes (e.g., nanomembranes) with aliphatic (e.g., alkyl) containing terminal groups should be considered indirect covalent bonding via any of the functionalization reactions described herein. The modification with aliphatic (e.g., alkyl) containing terminal groups is not direct but rather indirect, wherein any aliphatic or alkyl containing group is reacted with the functionalization groups disclosed herein (e.g., epihalohydrin or bifunctional aldehyde or silane) and not reacted directly with chemically-activated membrane (e.g., nanomembrane) surface reactive groups (e.g., —OH, —NH₂, and the like).

In other examples, the optional terminal group is also a surface property modifying group, such as a charged, non-polar, or amphiphilic group, such that the functionalization of silicon membranes with such terminal groups forms a coating wherein the surface properties of the silicon membrane correspond to those of these additional terminal group examples. These additional terminal groups can be linear, branched, or possess one or more charged, non-polar, or amphiphilic groups. Non-limiting examples of such groups may include linear and branched aliphatic groups (e.g., alkyl, alkenyl, and the like), primary, secondary, and tertiary amines having various aliphatic linear or branched groups covalently bonded thereto, carboxylates or sulfonates having various aliphatic linear or branched groups covalently bonded thereto, canonical amino acids such as alanine, leucine, isoleucine, valine, histidine, arginine, lysine, glutamate, aspartate, and the like, and non-canonical amino acids, such as, for example, ornithine, selenocysteine, fluorinated phenylalanine (e.g., pentafluorophenylalanine, p-fluorophenylalanine, and the like), and the like.

In various examples, the terminal groups are a mixture of non-fouling and surface property modifying groups.

In various examples, performing any of the reactions disclosed herein comprises contacting the membrane (e.g., nanomembrane) with either solution-phase and/or gas-phase reactant molecules, solutions comprising one or more reactants, or any combinations thereof.

The activation or treatment of the membrane surface by solution-phase chemistries, where reactive surface groups are formed, may be selected such that they are compatible with one or both silicon nitride (SiN) and/or silicon oxide (SiO₂) membranes (e.g., nanomembranes), as disclosed herein.

In an example, the functionalization methods are performed selectively, such that the entirety of a silicon membrane (e.g., nanomembrane) surface (e.g., on two (e.g., both) of its sides) are modified. In another example, only one of the membrane's (e.g., nanomembrane's) surfaces is selectively modified, while the opposing membrane surface remains unmodified. Further, the nanoporous, microporous, or microslit features of the membranes (e.g., nanomembranes) can be selectively functionalized within their intra-pore or intra-slit surfaces (e.g., the internal surface of a cylindrical nanopore and a micropore or the internal walls of a cubic prism microslit), while any other surface of the membrane (e.g., nanomembrane) remains unmodified or is selectively modified on one or more such surfaces. As a further alternative, the surface walls of the substrate aperture are selectively modified, while the other features of the membranes (e.g., nanomembranes) remain unmodified. Such functionalization methods may be performed on monolithic membranes (e.g., nanomembranes) as described herein.

As an example, any surface, pore, or slit feature is selectively masked such that the masking prevents functionalization, while unmasked surfaces are functionalized. For example, the masking comprises use of a photoresist, where the photoresist is disposed onto the first membrane surface of a microporous or microslit membranes (e.g., nanomembranes), such that any pore or slit features are not masked; i.e., the porous or slit features remain open and are not disposed by these coatings on their intra-pore or intra-slit surfaces. Subsequent to the disposition of the photoresist, any one of the functionalization methods disclosed herein may be used to modify the intra-pore or intra-slit surfaces, followed by removal of the photoresist in an appropriate solvent (e.g., acetone, developer solution, or toluene). The functionalization method would be selective for the unmasked membrane (e.g., nanomembrane) features such that it does not modify the photoresist. Alternatively, if the functionalization method should happen to modify the photoresist, such modified photoresist would be removed post-functionalization to expose an unmodified first membrane surface. Further, the photoresist can be selectively removed without disrupting the functionalized surface, pore or slit. Of course, other possible combinations of selective masking and/or functionalization may be carried out with any degree of iteration of surface, pore, and/or slit, and the above example has been provided for exemplary purposes only.

In an example, a method for functionalizing a silicon membrane (e.g., nanomembrane) comprises: contacting a membrane (e.g., nanomembrane) with a chemical oxidation solution; contacting the membrane (e.g., nanomembrane) with gas-phase epihalohydrin molecules; contacting the membrane (e.g., nanomembrane) with solution-phase acid or base catalysts; and contacting the membrane (e.g., nanomembrane) with gas-phase and/or solution-phase terminal moieties.

The chemical oxidation solution may comprise a solution of 80% w/v sulfuric acid (H₂SO₄) and 30% v/v hydrogen peroxide (H₂O₂), at a mixed ratio, respectively, of 3:1 to 20:1, including all integer ratio values and ranges therebetween. Such a mixed solution may be referred to as piranha solution. Alternatively, the chemical oxidation solution may comprise an aqueous solution of deionized water, 29% w/v ammonium hydroxide (NH4OH), and 30% v/v (H₂O₂, at a mixed ratio, respectively, of 5:1:1 to 8:0.5:1, including all integer ratio values and ranges therebetween. Such a solution may be referred to as RCA SC1 solution. Such chemical oxidation solutions likely form hydroxyl surface groups on SiN and SiO₂ membranes (e.g., nanomembranes) (i.e., Si—OH bonds). Contact with the chemical oxidation solution may be performed at a range of temperature and time duration. For example, contact with the solution may be from 25° to 150° C., including all 0.1° C. and ranges therebetween. The time duration may be from 1 to 20 minutes, including all 0.01 minute values and ranges therebetween. Concentration of any solution component, temperature, and time duration are likely to affect the extent of surface hydroxyl group formation.

The epihalohydrin molecules (i.e., epihalohydrins) may comprise epichlorohydrin or epibromohydrin molecules. The epoxide group of such epihalohydrins may react with the hydroxyl groups of the chemically oxidized membrane (e.g., nanomembrane), the reaction mechanism of which is known in the art. Gaseous epihalohydrin may be formed at a range of vapor pressure and/or temperature. For example, the vapor pressure may be 1.3 to 2666.5 Pascal, or any 0.01 Pascal value and range therebetween. The temperature may be 25° to 100° C., including all 0.1° C. and ranges therebetween. Contact of the membrane (e.g., nanomembrane) with the gaseous epihalohydrin may also be performed at a range of time duration; e.g., from 1 minute to 16 hours, including all 0.01 minute values and ranges therebetween. Vapor pressure, temperature, and time duration may likely affect the extent to which the membrane (e.g., nanomembrane) is derivative by the epihalohydrin.

The solution-phase acid or base catalysts may comprise an aqueous solution of a Lewis acid or Lewis base at a range of concentration and may promote the re-closure of the epoxide ring and removal of the halogen leaving group For example, the acid or base catalyst may comprise deionized water, 0.1% to 10% v/v hydrochloric acid (HCl), including all 0.1% values and ranges therebetween, 0.1% to 10% v/v sodium hydroxide (NaOH) or potassium hydroxide (KOH), including all 0.1% values and ranges therebetween. The acid or base catalysis may comprise a range of temperature and time duration. For example, the temperature is from 25° to 100° C., including all 0.1° C. and ranges therebetween, and the time duration may be from 1 minute to 60 minutes, including all 0.01 minute values and ranges therebetween. Such catalysts are likely to promote the removal of the halogen leaving group and re-closing of the epoxide ring, as known to those skilled in the art.

In some examples, a solution-phase or gas-phase spacer molecule is reacted with the epihalohydrin-reacted membrane (e.g., nanomembrane) prior to reacting said membrane (e.g., nanomembrane) with terminal moieties. The spacer molecule may comprise at least one amine group that reacts with the epoxide functional group of said treated membrane (e.g., nanomembrane) and at least one additional reactive group that reacts with one or more terminal moieties. In an example, the spacer molecule is glutaraldehyde, but many other possible spacer molecules could be used.

In another example, a method for functionalizing a silicon membrane (e.g., nanomembrane) comprises:
contacting a membrane (e.g., nanomembrane) with a chemical oxide etchant solution;
contacting the membrane (e.g., nanomembrane) with solution-phase or gas-phase aldehyde molecules;
contacting the membrane (e.g., nanomembrane) with solution-phase reductive amination agents; and
optionally, contacting the membrane (e.g., nanomembrane) with gas-phase and/or solution-phase terminal moieties.

The chemical oxide etchant solution may comprise an aqueous solution of hydrofluoric acid (HF) or buffered-oxide etchant (BOE, either of which selectively etches native surface SiO₂ on SiN and further forms surface amine groups (i.e., Si—NH₂). The aqueous solution of HF may comprise a range of concentration (e.g., 48% v/v HF may be diluted in deionized water to 0.1% to 10%, including all 0.1% values and ranges therebetween). Alternatively, BOE solutions may comprise a solution of deionized water, 40% v/v ammonium fluoride (NH₄F) and 48% v/v HF, at a mixed ratio, respectively, of 5:1:1 to 50:1:1, including all ratio values and ranges therebetween. As appreciated by those skilled in the art, such chemical oxide etchants would be incompatible with SiO₂ membranes (e.g., nanomembranes), and thus, this exemplary functionalization method is intended for SiN membranes (e.g., nanomembranes). Contact with the chemical oxide etchant solution may be performed at a range of temperature and time duration. For example, contact with the solution may be from 25° to 60° C., including all 0.1° C. and ranges therebetween. The time duration may be from 30 seconds to 3 minutes, including all 0.01 minute values and ranges therebetween. Concentration of solution components, temperature, and time duration are likely to promote extent of native oxide removal and amine group formation.

The aldehyde molecules (i.e., aldehydes) may comprise linear or branched aliphatic (e.g., alkyl) groups with 1-18 carbons with any degree of branching, and one or more terminal aldehyde groups (e.g., glutaraldehyde, or halogenated or hydroxylated substitutions and one or more terminal aldehyde groups (e.g., glyceraldehyde or other aliphatic groups (e.g., alkyl groups) that are terminated with at least one aldehyde and one or more hydroxyl substituents)). Reaction of the aldehyde groups with surface amine groups likely follows a reaction mechanism well-known to those skilled in the art; e.g., a reaction of the aldehyde and amine likely produces a Schiff base imine. The imine may be further reduced in order to promote its hydrolytic stability in the form of an amine that is linked to the membrane (e.g., nanomembrane) surface (i.e., Si—N—C bonds).

The gas-phase aldehydes may be formed at a range of vapor pressure and/or temperature. In various examples, the vapor pressure is 1.3 to 2666.5 Pascal, including all 0.1 Pascal values and ranges therebetween, and/or the temperature is 25° to 200° C., including all 0.1° C. values and ranges therebetween. Contact of the membrane (e.g., nanomembrane) with solution-phase aldehydes may comprise a range of concentration and/or temperature. For example, the aldehyde concentration is 1 μM to 10 M, including all integer μM values and ranges therebetween, and/or the temperature is from 25° to 100° C., including all 0.1° C. values and ranges therebetween. For both solution-phase and gas-phase aldehydes, the contact may be performed at a range of time duration; e.g., from 1 minute to 16 hours, including all second and minute values and ranges therebetween. Vapor pressure, concentration, temperature, and time duration may likely affect the extent to which the membrane (e.g., nanomembrane) is derivatized by the aldehyde.

The contact with the aldehydes may further comprise use of a dehydrating agent; e.g., a molecular sieve, magnesium sulfate, tris(2,2,2-trifluoroethyl)borate, or titanium ethoxide, and the like. Such dehydrating agents may promote formation of the Schiff base amine, as the equilibrium of amine formation from aldehydes and amines may favor the carbonyl compound and the amine reactants.

The solution-phase reductive amination agents may comprise an aqueous solution of, for example, sodium borohydride (NaBH₄), sodium cyanoborohydride (NaBH₃CN), or sodium triacetoxyborohydride (NaBH(OCOCH₃)₃), and the like. Such agents may be at a range of concentration; e.g., 1 μm to 1 mM, including all 0.1 μM values and ranges therebetween. The reductive amination may be performed at a range of temperature (e.g., 25° to 100° C., including all 0.1° C. values and ranges therebetween) and/or for a range of time duration (e.g., 1 minute to 60 minutes, including all integer second values and ranges therebetween).

In a further example, a method disclosed herein is combined with well-known silane functionalization methods, such that the combination improves the density of surface functionalization coverage, and therefore, may improve the hydrolytic stability of the silane-functionalized surface. Such combined functionalization methods may rely upon selective mechanisms and reactive groups for the one or more functionalization methods. For example, the method disclosed herein for amine group functionalization (e.g., aldehyde reactions) may be combined with a method for hydroxyl group functionalization (e.g., silane reactions).

In various examples of the combined functionalization method, the molecular size of the aldehyde derivative should be specified such that it does not sterically hinder further surface derivatization with the silane derivative. Further, it is desirable that the size of the silane derivative be specified such that it is not sterically hindered by the preceding derivatization of the membrane (e.g., nanomembrane) with the aldehyde derivative. Thus, the number of atoms (e.g., number of atoms in an aliphatic group (e.g., methylene groups (e.g., carbons)) in a chain), number of reactive functional groups, and/or extent of chain branching may be specified for both the aldehyde and silane derivatives. For example, the aldehyde comprises two reactive groups and a five-carbon aliphatic (e.g., alkyl) chain, while the silane comprises one reactive group, two leaving groups, and a two-carbon aliphatic (e.g., alkyl) chain that further branches at the terminal carbon with two methyl groups. Other combinations of which are known in the art. In an example, the silicon membrane (e.g., nanomembrane) is not functionalized solely with a silane.

In a further example, a method for a combined functionalization of a silicon membrane (e.g., nanomembrane) comprises: contacting a membrane (e.g., nanomembrane) with a chemical oxide etchant solution; contacting the membrane (e.g., nanomembrane) with solution-phase or gas-phase aldehyde molecules; contacting the membrane (e.g., nanomembrane) with solution-phase reductive amination agents; contacting the membrane (e.g., nanomembrane) with solution-phase or gas-phase silane molecules; and optionally, contacting the membrane (e.g., nanomembrane) with gas-phase and/or solution-phase terminal moieties.

In examples of a combined functionalization, the method for contacting a membrane (e.g., nanomembrane) with solution-phase and/or gas-phase chemical oxide etchants, aldehydes, and reductive amination agents comprises the steps disclosed herein for such contacting steps when only aldehyde-based functionalization is been performed.

The solution-phase or gas-phase silane molecules may comprise, for example, chloro(dimethyl)(pentafluorophenyl)silane or chloro(dimethyl)silyl trifluoromethanesulfonate, and the like, that may comprise their own inherent terminal moieties with non-fouling properties. The solution-phase or gas-phase silane molecules may further comprise a first reactive group that reacts with the substrate surface hydroxyl groups and a second reactive group that reacts with optional terminal moieties as disclosed herein, such silanes acting as spacer molecules and may include, for example, ethyl 3-[chloro(dimethyl)silyl]acrylate or (3-glycidoxypropyl)trimethoxysilane, and the like.

The gas-phase silane molecules may be formed at a range of vapor pressure and/or temperature. In various examples, the vapor pressure is 1.3 to 2666.5 Pascal, including all 0.1 Pascal values and ranges therebetween and/or the temperature is 25° to 200° C., including all 0.1° C. values and ranges therebetween. Contact of the membrane (e.g., nanomembrane) with solution-phase silane molecules may comprise a range of concentration and/or temperature. For example, the silane molecule concentration is 1 μM to 10 mM, including all 0.1 μM values and ranges therebetween and/or the temperature is from 25° to 100° C., including all 0.1° C. values and ranges therebetween. For both solution-phase and gas-phase silane molecules, the contact may be performed at a range of time duration; e.g., from 1 minute to 16 hours, including all integer second values and ranges therebetween. Vapor pressure, concentration, temperature, and time duration may likely affect the extent to which the membrane (e.g., nanomembrane) is derivatized by the silane.

In some examples of the combined functionalization method, an optional oxidation step precedes contact with the silane(s). For example, a rinse in deionized water for 1 to 10 minutes at 25° to 100° C., including all 0.1° C. values and ranges therebetween, is used to re-form substrate surface hydroxyl groups. Such hydroxyl groups may be removed by oxide etchants, thus, increasing their density may improve the extent to which silanes derivatize the membranes (e.g., nanomembranes) in subsequent reactions.

In the various examples, contact with the solution-phase and gas-phase reactants is sequentially performed or concurrently performed in any combination of the various steps. The steps are performed in suitable reaction vessels for such reactions (e.g., specified volume and surface properties, temperature control, fluidic valves for adding and removing reactants, pumps for controlling vapor pressure, and the like). Further, any of the sequentially and/or concurrently performed steps may be carried out in one common vessel (to which various reactants are added and removed as required for carrying out the method) or in a series of independent vessels (to which various reactants are added and removed and silicon membranes (e.g., nanomembranes) transferred between such vessels, to carry out the method).

In the various examples, optional rinsing or cleaning steps precede or follow any of the steps disclosed herein. Such rinsing or cleaning steps may be performed to remove any chemisorbed or physisorbed reactants and/or reaction products, and the like. The rinsing and cleaning may be carried out with a variety of polar or non-polar solutions; e.g., water, acetone, toluene, dichloromethane, hexane, ethanol, methanol, and the like. Further, an optional drying step may precede or follow any of the steps disclosed herein. For example, membranes (e.g., nanomembranes) may be functionalized by a method of the present disclosure, optionally rinsed in ultra-pure water, then dried under a stream of anhydrous nitrogen gas. Of course, many other possibilities for such optional rinsing, cleaning, and drying steps are possible.

In the various steps of the method disclosed herein, the reaction is monitored by one or more suitable metrology modalities; e.g., variable angle ellipsometry, x-ray photoelectron spectroscopy ( )PS), low-energy ion scattering (LEIS), atomic force microscopy (AFM), scanning or transmission electron microscopy (SEM or TEM), contact angel goniometry, infrared absorption spectroscopy (IRAS), and the like.

In an aspect, the present disclosure describes fluidic devices incorporating at least one functionalized silicon membrane (e.g., nanomembrane) and uses of such fluidic devices. For example, a fluidic device is used for filtration applications or methods.

In various examples, a fluidic device comprises at least one functionalized silicon membrane (e.g., nanomembrane), and further comprises a plurality of fluidic channels or chambers (e.g., a first fluidic channel or chamber, a second fluidic channel or chamber, etc.) in fluidic contact with a plurality of membrane surfaces (e.g., a first membrane, a second membrane, etc.), such as, for example, a first fluidic channel or chamber in fluidic contact with a first membrane surface and at least one second fluidic channel or chamber in fluidic contact with the at least one second membrane surface and one or more aperture, and the plurality of fluidic channels and/or chambers (e.g., a first and second fluidic channels and/or chambers) in fluid contact with each other via the aperture and the nanopores, micropores, or microslits, of the membrane.

In various examples, a fluidic devices comprises a first fluidic channel and/or chamber in fluidic contact with the silicon substrate; a second fluidic channel and/or chamber in fluid contact with the membrane (e.g., nanomembrane); and wherein the first fluidic channel and/or chamber is in fluidic communication with the second fluidic channel by way of the aperture and the plurality of nanopores, micropores, or microslits of the membrane. In various examples, a first plurality of fluidic channels and/or chambers are in fluidic contact with a silicon substrate (e.g., silicon wafer); a second plurality of fluidic channels and/or chambers are in fluidic contact with the membrane (e.g., nanomembrane), wherein the first plurality of fluidic channels and/or chambers are in fluidic communication with a second plurality of fluidic channels and/or chambers by way of an aperture and a plurality of nanopores, micropores, or microslits.

In various examples, wherein one or more additional apertures extend through the thickness of the silicon substrate, and wherein the first fluidic channel and/or chamber (or plurality thereof) is further in fluidic communication with the second fluidic channel and/or chamber (or plurality thereof) by way of the one or more additional apertures.

In various examples, a method of performing a filtration comprises: contacting an input solution with a functionalized silicon membrane, where the input solution contacts at least one first membrane surface of a membrane; and, collecting a volume of the input solution that permeates through the membrane, where the volume is collected on the opposing at least second membrane surface and/or at least one aperture.

In an example, contacting the input solution with the at least one first membrane surface comprises normal or tangential flow relative to said membrane surface, where such flow comprises one of gravity flow, hydrostatic pressure, pumping, vacuum, centrifugation, gas pressurization, or combinations thereof. In another example, the method further comprises contacting the at least one second membrane surface and/or at least one aperture with an optional second solution during collection of the permeating volume of the input solution.

In other examples, contacting the at least one second membrane surface and/or at least one aperture with an optional second solution further comprises flowing the optional second solution parallel with, perpendicular to, or counter to, the flow of the input solution. In this example, permeation of solutes from the input solution to any optional second solution or permeation of solutes from any optional second solution to the input solution may occur.

In an example, the filtration device (e.g., fluidic device) is a system configured to perform hemodialysis, where blood passes over one surface of the silicon membrane functionalized with a non-fouling coating, and a counter-flowing dialysate solution passes over the opposite surface of the silicon membrane. It is expected that such a filtration device could be part of a treatment for end-stage kidney disease. The non-fouling coating on the functionalized silicon membrane would be required for the prevention of non-specific absorption of blood constituents onto the membrane, for the prevention of clot formation, activation of platelets, and the like. Such a filtration process may be described as a tangential flow filtration process, wherein solutes permeate from blood to dialysate (and vice versa) during the course of filtration.

In an example, the filtration device (e.g., fluidic device) is a system configured to perform a routine separation, where an input solution contacts the silicon membrane functionalized with one or more coatings of the present disclosure. In routine separations, a volume of the input solution permeates through the membrane and can be collected on the opposing side of the membrane. Additionally, a dialysate or buffer can be added to either the input solution and/or the opposing side of the membrane during the course of the filtration. Such routine separations can be used to separate various solutes based on size and other physical properties (e.g., charge or hydrophilicity/hydrophobicity) and can be used to retain certain solutes, concentrate solutes, and/or exchange the buffer or other components of the input solution with those of the added dialysate or buffer.

In various examples, these routine separations are performed as a tangential flow filtration process, where solutes permeate from the input solution to any optional buffer or dialysate added to the second side of the membrane (and vice versa) during the course of filtration. As another example, the filtration device could be a dead-end or normal flow filtration device, where solutes from the input solution selectively permeate from the first side of the contacting silicon membrane to the opposing side of the contacting silicon membrane. In both tangential and normal flow examples, the one or more coating on the functionalized silicon membrane would be required for the prevention of non-specific absorption of solution constituents, promoting the wetting of the membrane, and/or modulating the selective separation properties of the membrane.

In an example of a routine separation, the tangential or normal flow filtration devices are used to perform separations of size-specific fractions of laboratory solutions, such as those comprising analytical-scale volumes and concentrations of proteins, cells, or nucleic acids (and the like). In yet another example, the tangential or normal flow filtration devices are used to perform separations of size-specific fractions of clinical solutions, such as whole blood, prepared blood products, or preparations thereof (e.g., erythrocytes, leukocytes, platelets, plasma, serum, and the like), cerebral spinal fluid, urine, and other endogenous biofluids not specifically named. In yet another example, the tangential or normal flow filtration devices are used to perform separations of industrial solutions, such as chemical, pharmaceutical, synthetic, recombinant or naturally derived proteins, viruses or cells, and food, and the like.

In an example, the filtration device (e.g., fluidic device) is a system configured to perform a sterile filtration, where an input solution contacts the silicon membrane functionalized with one or more coatings of the present disclosure. In a sterile filtration, a volume of the input solution permeates through the membrane and can be collected on the opposing side of the membrane. Additionally, a sterile dialysate or buffer can be added to either the input solution and/or the opposing side of the membrane during the course of the filtration. Of particular importance for sterile filtration, the filtration can be used to retain possible microbial contaminants (e.g., microbes, such as, for example, viruses, bacteria, fungi, and the like) from the input solution, based on physical properties (e.g., size, charge or hydrophilicity/hydrophobicity of the microbes), and further to permeate a volume of the input solution that is substantially devoid of any such microbes and thus is considered a sterilized solution. Further, solutes may co-permeate with the permeating volume of input solution that passes through the membrane and thus may be considered sterilized solutes. Such solute permeation may be based on their physical properties (e.g., size, charge or hydrophilicity/hydrophobicity).

In various examples, sterile filtration can be performed as a tangential flow filtration process, where microbes are retained and the volume and the solutes of the input solution permeate from the input solution to any optional buffer or dialysate added to the second side of the membrane during the course of filtration. As another example, the filtration device could be a dead-end or normal flow filtration device, where the volume and the solutes from the input solution selectively permeate from the first side of the contacting membrane to the opposing side of the contacting membrane, while any microbes are retained on the first side of the contacting membrane. In both tangential and normal flow examples, the one or more coating on the functionalized silicon membrane would be required for the prevention of non-specific absorption of solution constituents, promoting the wetting of the membrane, and/or modulating the selective separation properties of the membrane.

In an example of sterile filtration, the tangential or normal flow filtration devices are used to perform sterilization of laboratory solutions, such as those comprising analytical-scale volumes and concentrations of conditioned cell culture media, ascites fluid, proteins, nucleic acids, lipids, cells, viruses, extracellular vesicles, nanoparticles, and any combinations thereof, among other examples. In yet another example, the tangential or normal flow filtration devices are used to perform sterilization of clinical solutions, such as whole blood, prepared blood products, extracellular vesicles, or preparations thereof (e.g., erythrocytes, leukocytes, platelets, plasma, serum, and the like), cerebral spinal fluid, urine, and other endogenous biofluids not specifically named. In yet another example, the tangential or normal flow filtration devices are used to perform sterilization of industrial solutions, such as chemical, pharmaceutical, synthetic, recombinant or naturally derived proteins, viruses or cells, milk, food products, nanoparticles, antibody-drug conjugates, and the like. In yet other examples, one or more of the sterile filtered laboratory, clinical, and/or industrial solutions are combined as a product for various applications, purposes, and needs.

In an example of performing a sterile filtration, the solutes to be sterilized by permeation through a functionalized silicon membrane of the present disclosure may comprise a solute intended for use in clinical applications; e.g., the solute should be sterilized as part of formulating an injectable therapeutic agent. For example, the solute may be a solution of extracellular vesicles (e.g., exosomes or the like) that should be sterilized for use as a drug delivery or vaccination vehicle. In another example, the solute may be a solution of nanoparticles or antibody-drug conjugates, wherein the nanoparticles or antibody-drug conjugates have been engineered, for example, as drug delivery vehicles, therapeutics, or as genetic engineering vectors, and thus should be sterilized for use as an administrable therapeutic agent. In yet another example, the solute is a solution of one or more naturally-occurring viruses and/or one or more viruses that have been engineered, for example, as oncolytic, gene therapy, or vaccination agents, and thus should be sterilized for use as an administrable therapeutic agent. In such examples involving viruses, the desired permeating solute is the virus in monomeric form that has been filtered from possible contamination by other microbes and/or aggregates of the same virus in multimeric forms.

In a preferred example of a sterile filtration, the functionalized silicon membrane (e.g., nanomembrane) may comprise a microslit silicon nitride membrane of 0.2, 0.3, 0.4, 0.5, 0.6, 0.7, or 0.8 μm width. In a preferred example, the functionalized silicon membrane (e.g., nanomembrane) has a microslit width of 0.2 μm to 0.4 μm, including all integer 0.01 μm values and ranges therebetween. In another example, the functionalized silicon membrane (e.g., nanomembrane) has a microslit width of 0.2 μm to 0.8 μm, including all integer 0.01 μm values and ranges therebetween. Notwithstanding these preferred examples, other nanoporous or microporous silicon membranes as disclosed herein can be used for sterile filtration. The steps of the method described in the various embodiments and examples disclosed herein are sufficient to carry out the methods of the present disclosure. Thus, in an embodiment, a method consists essentially of a combination of steps of the methods disclosed herein. In another embodiment, a method consists of such steps.

In the following Statements, various examples of the present disclosure are described:
Statement 1. A method for functionalizing a silicon membrane (e.g., nanomembrane) comprising:
   a) contacting a membrane (e.g., nanomembrane) with one or more chemical oxidant (e.g., one or more chemical oxidation solution);
   b) contacting the membrane (e.g., nanomembrane) with one or more epihalohydrin molecules (e.g., one or more gas-phase epihalohydrin molecules);
   c) contacting the membrane (e.g., nanomembrane) with one or more acid or base catalyst (e.g., one or more solution-phase acid or base catalyst); and,
   d) contacting the membrane (e.g., nanomembrane) with one or more terminal moiety forming molecules (e.g., one or more gas-phase and/or solution-phase terminal moiety forming molecules).
Statement 2. The method according to Statement 1, where the chemical oxidation contacting (e.g., treatment) comprises a solution of hydrogen peroxide and sulfuric acid or ammonium hydroxide and hydrogen peroxide.
Statement 3. The method according to Statement 1 or Statement 2, where the epihalohydrin is gaseous epichlorohydrin or epibromohydrin.
Statement 4. The method according to any one of the preceding Statements, where the one or more gas-phase epihalohydrin has a vapor pressure of 1.3-2666.6 Pascal, including all 0.01 Pa values and ranges therebetween (e.g., between 1.3 and 2666.6 Pa).
Statement 5. The method according to any one of the preceding Statements, where the one or more solution-phase acid or solution-phase base catalyst comprises a Lewis acid or Lewis base, respectively.
Statement 6. The method according to any one of the preceding Statements, where the one or more terminal moiety forming molecule is an amine-containing molecule in either gas-phase or solution-phase, where such terminal moieties comprise non-fouling or surface property modifying groups, or any combination thereof.
Statement 7. The method according to any one of the preceding Statements, where the method further comprises contacting the membrane (e.g., nanomembrane) with one or more spacer forming molecule (e.g., one or more solution-phase or gas-phase spacer forming molecule) prior to contacting said membrane (e.g., nanomembrane) with one or more solution-phase or gas-phase terminal moiety forming molecule, where the spacer molecule comprises at least one amine group, an aliphatic (e.g., alkyl) chain of two or more carbons, and at least one second reactive group.
Statement 8. A method for functionalizing a silicon membrane (e.g., nanomembrane) comprising:
   a) contacting a membrane (e.g., nanomembrane) with one or more chemical oxidant (e.g., a chemical oxidation solution);
   b) contacting the membrane (e.g., nanomembrane) with one or more aldehyde molecules (e.g., one or more solution-phase or gas-phase aldehyde molecules that are the same or different);
   c) contacting the membrane (e.g., nanomembrane) with one or more reductive amination agents (e.g., one or more solution-phase reductive amination agents); and,
   d) optionally, contacting the membrane (e.g., nanomembrane) with one or more terminal moiety forming molecules (e.g., one or more gas-phase and/or solution-phase terminal moiety forming molecules).
Statement 9. The method according to Statement 8, where the chemical oxide etchant solution comprises an aqueous solution of hydrofluoric acid or ammonium fluoride and hydrofluoric acid.
Statement 10. The method according to Statement 8 or 9, where the one or more gas-phase aldehydes comprise a vapor pressure of 1.3 to 2666.3 Pascal.
Statement 11. The method according to any one of Statements 8-10, where the one or more solution-phase aldehydes comprise a solution of 1 μm to 10 M concentration.
Statement 12. The method according to any one of Statements 8-11, where the method further comprises optional use of a dehydrating agent.
Statement 13. The method according to any one of Statements 8-12, where the one or more solution-phase reductive amination agents comprise an aqueous solution of sodium borohydride, sodium cyanoborohydride, sodium triacetoxyborohydride, or a combination thereof.
Statement 14. The method according to any one of Statements 8-13, where the solution-phase or gas-phase aldehydes further comprise at least one aldehyde group, at least one aliphatic (e.g., alkyl) chain length of three or more carbons, and at least one terminal moiety.
Statement 15. The method according to any one of Statements 8-13, where the solution-phase or gas-phase aldehydes further comprise at least two aldehyde groups and an aliphatic (e.g., alkyl) chain length of three or more carbons, where such aldehyde molecules comprise spacer groups.
Statement 16. The method according to any one of Statements 8-15, where the method further comprises reacting the one or more aldehyde spacer forming molecule one or more terminal moieties, where such terminal moieties comprise non-fouling or surface property modifying groups, or any combination thereof.
Statement 17. A further method for a combined functionalization of a silicon membrane (e.g., nanomembrane), the further combined method comprising:
   a) contacting a membrane (e.g., nanomembrane) with one or more chemical oxidant (e.g., one or more chemical oxidation solution);
   b) contacting the membrane (e.g., nanomembrane) with one or more aldehyde molecules (e.g., solution-phase or gas-phase aldehyde molecules that are the same or different);
   c) contacting the membrane (e.g., nanomembrane) with one or more reductive amination agent (e.g., one or more solution-phase reductive amination agents);
   d) contacting the membrane (e.g., nanomembrane) with one or more silane molecules (e.g., one or more solution-phase and/or gas-phase silane molecules; and,
   e) optionally, contacting the membrane (e.g., nanomembrane) with one or more terminal moiety forming molecules (e.g., one or more gas-phase and/or solution-phase terminal moiety forming molecules).
Statement 18. The method according to Statement 17, where the method further comprises any one of the chemical oxide etchant solutions of Statement 9, optional dehydration agents of Statement 12, reductive amination agents of Statement 13, and aldehydes of Statement 10, 11, and 14-16, or a combinations thereof.
Statement 19. The method according to Statements 17 or 18, where the gas-phase silanes comprise a vapor pressure of 1.3 to 2666.5 Pascal.
Statements 20. The method according to any one of Statements 17-19, where the solution-phase silanes comprise a solution of 1 μm to 1 mM concentration.
Statements 21. The method according to any one of Statements 17-20, where the solution-phase or gas-phase silanes further comprise at least one silane group, at least one aliphatic (e.g., alkyl) chain length of three or more carbons, and at least one terminal moiety.
Statements 22. The method according to any one of Statements 17-20, where the solution-phase or gas-phase silanes further comprise at least one silane group, at least one reactive or leaving group, at least one aliphatic (e.g., alkyl) chain length of three or more carbons, where such silanes comprise spacer groups.
Statement 23. The method according to any one of Statements 17-22, where the method further comprises reacting the silane spacers with one or more terminal moiety forming molecules (e.g., one or more gas-phase and/or solution-phase terminal moiety forming molecules), where such terminal moieties comprise non-fouling or surface property modifying groups, or any combination thereof.
Statement 24. The methods according to any one of Statements 17-23, where the molecular sizes (e.g., molecular volume) of the aldehydes and silanes are specified relative to each other, such that neither sterically hinders the derivatization of substrate surface groups.
Statement 25. The method according to any one of the preceding Statements, where the method further comprises cross-linking any of the derivatized molecules.
Statement 26. The method according to any one of the preceding Statements, where the method further comprises selective functionalization of one or more first membrane surface, one or more second membrane surface, one or more aperture, or one or more intra-pore or intra-slit surface, or any combinations thereof.
Statement 27. A functionalized silicon membrane (e.g., nanomembrane) (e.g., a functionalized silicon membrane (e.g., nanomembrane) made according to any one of Statements 1-26), where the silicon membrane (e.g., nanomembrane) comprises any one of the group selected from a nanoporous silicon nitride membrane, a microporous silicon nitride membrane, a microslit silicon nitride membrane, or a microporous silicon oxide membrane, and, for example, the functionalization comprises at least one dimension (e.g., a thickness) that is less than 20% of mean pore diameter or microslit width.
Statement 28. The functionalized membrane (e.g., nanomembrane) according to Statement 27, where the membrane (e.g., nanomembrane) further comprises at least one first surface, at least one second surface (e.g., opposing surface), and a plurality of nanopores, micropores, or microslits passing therebetween.
Statement 29. The functionalized membrane (e.g., nanomembrane) according to Statements 27 or 28, where the membrane further comprises a nanopore or micropore diameter, or a microslit width, that is 11 nm to 10 μm, including every 0.1 nm value and range therebetween.
Statement 30. The functionalized membrane (e.g., nanomembrane) according to any one of Statements 27-29, where the membranes (e.g., nanomembranes) have a nanopore, a micropore, or a microslit density of 10² to 10¹⁰ pores/mm².
Statement 31. The functionalized membrane (e.g., nanomembrane) according to any one of Statements 27-30, where the membrane (e.g., nanomembrane) comprises a layer disposed on a silicon wafer substrate of <100> or <110> crystal orientation, and further where one or more aperture extends through the thickness of the silicon wafer, such that at least one first membrane surface and at least one second (i.e., opposing) membrane surface are formed by the at least one aperture, and the plurality of nanopores, micropores, or microslits, are fluidically connected to the at least one aperture.
Statement 32. The functionalized membrane (e.g., nanomembrane) according to any one of Statements 27-31, where the membrane (e.g., nanomembrane) thickness comprises 20 nm to 10 μm.
Statement 33. The functionalized membrane (e.g., nanomembrane) according to any one of Statements 27-32, where the membrane (e.g., nanomembrane) further comprises one or more selectively functionalized first membrane surface, second membrane surface, aperture, or intra-pore or intra-slit surface, or any combinations thereof.
Statement 34. The functionalized membrane according to any one of Statements 27-33, where the terminal group is a group that promotes non-fouling (e.g., a non-fouling group, such as, for example, sulfobetaine, sulfobetaine analogs and derivatives thereof, Fmoc-lysine, hydroxylamine-O-sulfonic acid, 3-(amidinothio)-1-propanesulfonic acid, 6-carbon to 8-carbon long terminal aldehydes with heavily fluorinated alkyl/aliphatic chains, perfluoro octanesulfonamide, ethanolamine, peptides (e.g., KEK) and/or is surface property modifying (e.g., a surface property modifying group, such as, for example, linear aliphatic groups, branched aliphatic groups, charged groups, non-polar groups, amphiphilic groups, primary amines, secondary amines, tertiary amines, carboxylates of various carbon chain length, sulfonates of various carbon chain length, and amino acids (including both canonical and non-canonical amino acids).
Statement 35. The functionalized membrane according to any one of Statements 27-34, where the functionalized membrane has a functionalized surface density of 20% to 100% surface coverage extent.
Statement 36. A fluidic device comprising at least one functionalized silicon membrane according to any one of Statements 27-35 or at least one functionalized silicon membrane prepared by a method of any one of Statements 1-27.
Statement 37. The fluidic device according to Statement 36, where the fluidic device further comprises at least one first fluidic channel or chamber in fluidic contact with the at least first membrane surface and at least one second fluidic channel or chamber in fluidic contact with the at least one second membrane surface and at least one aperture, and the at least first and second fluidic channels and/or chambers in fluid contact with each other via the nanopores, micropores, or microslits, of the membrane.
Statement 38. The fluidic device according to Statements 36 or 37, where the fluidic device further comprises a device for performing a filtration.
Statement 39. A method of performing a filtration, the method comprising:
a) contacting an input solution with a functionalized silicon membrane, where the input solution contacts at least one first membrane surface of a membrane; and,
b) collecting (e.g., by filtration) a volume of the input solution that permeates through the membrane, where the volume is collected on the opposing at least second membrane surface and/or at least one aperture.
Statement 40. The method according to Statement 39, where contacting the input solution with the at least one first membrane surface comprises normal or tangential flow relative to said membrane surface, where such flow comprises one of gravity flow, hydrostatic pressure, pumping, vacuum, centrifugation, gas pressurization, or any combinations thereof.
Statement 41. The method according to Statements 39 or 40, where the method further comprises contacting at least one second membrane surface and/or at least one aperture with an optional second solution during collection of the permeating volume of the input solution.
Statement 42. The method according to Statement 41, where contacting the at least one second membrane surface and/or at least one aperture with the optional second solution further comprises flowing the optional second solution parallel with, perpendicular to, or counter to, the flow of the input solution.
Statement 43. The method according to any one of Statements 39-42, further comprising permeation of solutes from the input solution to any optional second solution or permeation of solutes from any optional second solution to the input solution.
Statements 44. The method according to any one of Statements 39-43, where performing the filtration comprises using one or more fluidic devices according to any one of Statements 36-38.
Statement 45. The method according to any one of Statements 39-44, where the input solution comprises a laboratory, clinical, or industrial solution, and any optional second solution comprises a dialysate or buffer, such that performing the filtration comprises a routine separation.
Statement 46. The method according to any one of Statements 39-44, where the input solution comprises a laboratory, clinical, or industrial solution, and any optional second solution comprises a dialysate or buffer, such that performing the filtration comprises a sterile filtration.
Statement 47. The method according to any one of Statements 39-44, where the input solution comprises blood and any optional second solution comprises a dialysate, such that performing the filtration comprises hemodialysis.
Statement 48. A method for functionalizing a silicon membrane (e.g., nanomembrane) comprising:
   a) contacting a membrane (e.g., nanomembrane) with one or more chemical oxidant;
   b) contacting the membrane (e.g., nanomembrane) with one or more epihalohydrin molecules;
   c) contacting the membrane (e.g., nanomembrane) with one or more acid or base catalyst; and
   d) contacting the membrane (e.g., nanomembrane) with one or more terminal group forming compounds.
Statement 49. A method according to Statement 48, where the chemical oxidant comprises a solution of hydrogen peroxide and sulfuric acid or ammonium hydroxide and hydrogen peroxide.
Statement 50. A method according to Statement 48 or 49, where the one or more epihalohydrin is gaseous and chosen from epichlorohydrin and epibromohydrin.
Statement 51. A method according to any one of Statements 48-50, where the one or more gaseous epihalohydrin has a vapor pressure of 1.3-2666.6 Pascal.
Statement 52. A method according to any one of Statements 48-51, where the one or more acid or base catalyst comprises a Lewis acid or Lewis base, respectively.
Statement 53. A method according to any one of Statements 48-52, where the one or more terminal group forming compound is an amine-containing molecule in either gas-phase or solution-phase, where the one or more terminal groups comprise non-fouling or surface property modifying groups, or a combination thereof.
Statement 54. A method according to any one of Statements 48-53, further comprising contacting the membrane (e.g., nanomembrane) with one or more spacer forming compound (e.g., spacer forming molecule) prior to contacting the membrane (e.g., nanomembrane) with one or more solution-phase or gas-phase terminal group forming compound, where the spacer forming compound (e.g., spacer molecule) comprises one or more amine group, an aliphatic chain of two or more carbons, and one or more second reactive group.
Statement 55. A method for functionalizing a silicon membrane (e.g., nanomembrane) comprising:
   a) contacting a membrane (e.g., nanomembrane) with one or more chemical oxidant;
   b) contacting the membrane (e.g., nanomembrane) with one or more aldehyde;
   c) contacting the membrane (e.g., nanomembrane) with one or more reductive amination agents; and
   d) optionally, contacting the membrane (e.g., nanomembrane) with one or more terminal group forming compound.
Statement 56. A method according to Statement 55, where the chemical oxide etchant comprises an aqueous solution of hydrofluoric acid or ammonium fluoride and hydrofluoric acid.
Statement 57. A method according to Statement 55 or Statement 56, where the one or more aldehyde is gaseous and has a vapor pressure of 1.3 to 2666.3 Pascal.
Statement 58. A method according to Statement 55 or Statement 56, where the one or more aldehyde comprises a solution of 1 μM to 10 M total aldehyde (e.g., the total concentration of all aldehyde in solution, which may be the same or different, 1 μM to 1 mM).
Statement 59. A method according to any one of Statements 55-58, further comprising using a dehydrating agent (e.g., molecular sieve, magnesium sulfate, tris(2,2,2-trifluoroethyl)borate, or titanium ethoxide, and the like).
Statement 60. A method according to any one of Statements 55-59, where the one or more solution-phase reductive amination agent comprises an aqueous solution of sodium borohydride, sodium cyanoborohydride, sodium triacetoxyborohydride, or a combination thereof.
Statement 61. A method according to any one of Statements 55-60, where an aldehyde of the one or more aldehyde comprises one or more aldehyde functional group, one or more aliphatic chain length of three or more carbons, and one or more one terminal group.
Statement 62. A method according to any one of Statements 55-61, where an aldehyde of the one or more aldehyde comprises at least two aldehyde groups and an aliphatic chain length of three or more carbons.
Statement 63. A method according to any one of Statements 55-62, where the terminal groups comprise non-fouling or surface property modifying groups, or a combination thereof.
Statement 64. A method according to any one of Statements 55-63, further comprising contacting the membrane with one or more silane between c) and d).
Statement 65. A method according to any one of Statements 55-64, where the chemical oxide etchant comprises an aqueous solution of hydrofluoric acid or ammonium fluoride and hydrofluoric acid, the reductive amination agent comprises an aqueous solution of sodium borohydride, sodium cyanoborohydride, sodium triacetoxyborohydride, or a combination thereof, and the one or more aldehyde comprises one or more aldehyde group, one or more aliphatic group of three or more carbons, and at least one terminal group or at least two aldehyde groups and an aliphatic group of three or more carbons.
Statement 66. A method according to Statement 64 or 65, where the one or more silane is gaseous and has a vapor pressure of 1.3-2666.5 Pascal.
Statement 67. A method according to Statement 64 or 65, where the one or more silane comprises a solution of 1 μM to 1 mM total silane (e.g., the total concentration of all silane in solution, which may be the same or different, is 1 μM to 1 mM).
Statement 68. A method according to any one of Statements 64-67, where the one or more silane comprises at least one silane group, at least one aliphatic group of three or more carbons, and at least one terminal group.
Statement 69. A method according to any one of Statements 64-68, where the one or more silane comprises at least one silane group, at least one reactive or leaving group, at least one aliphatic group of three or more carbons.
Statement 70. A method according to any one of Statements 64-69, where the terminal groups comprise non-fouling or surface property modifying groups, or a combination thereof.
Statement 71. A method according to any one of Statements 64-70, where the molecular sizes of the aldehydes (e.g., one or more aldehyde) and silanes (e.g., one or more silane) are specified relative to each other, such that neither sterically hinders the derivatization of substrate surface groups.
Statement 72. A method according to any one of the preceding Statements, further comprising cross-linking any of the functional groups disposed on a membrane surface.
Statement 73. A method according to any one of Statements 48-72, further comprising selective functionalization of a plurality of membrane surfaces, one or more aperture, or one or more intra-pore or intra-slit surface, or a combination thereof.
Statement 74. A functionalized silicon membrane (e.g., nanomembrane), where the silicon membrane (e.g., nanomembrane) is chosen from a nanoporous silicon nitride membrane, a microporous silicon nitride membrane, a microslit silicon nitride membrane, and a microporous silicon oxide membrane.
Statement 75. A functionalized silicon membrane (e.g., nanomembrane) according to Statement 74, where the functionalization comprises at least one dimension that is less than 20% of mean pore diameter or microslit width.
Statement 76. A functionalized silicon membrane (e.g., nanomembrane) according to Statement 74 or Statement 75, further comprising a plurality of membrane surfaces (e.g., a first membrane surface and a second membrane surface) and a plurality of nanopores, micropores, or microslits passing therebetween.
Statement 77. A functionalized silicon membrane (e.g., nanomembrane) according to any one of Statements 74-76, where the functionalized silicon membrane (e.g., nanomembrane) has a nanopore or micropore diameter, or a microslit width of 11 nm to 10 μm.
Statement 78. A functionalized silicon membrane (e.g., nanomembrane) according to any one of Statements 74-77, where the membranes (e.g., nanomembranes) have a nanopore, a micropore, or a microslit density of 10² to 10¹⁰ pores/mm².
Statement 79. A functionalized silicon membrane (e.g., nanomembrane) according to any one of Statements 74-78, further comprising a silicon substrate of <100> or <110> crystal orientation, and where the membrane (e.g., nanomembrane) is disposed on the silicon substrate (e.g., silicon wafer).
Statement 80. A functionalized silicon membrane (e.g., nanomembrane) according to Statement 79, where an aperture extends through the thickness of the silicon substrate such that a first membrane surface is formed by the aperture, and at least some of the plurality of nanopores, micropores, or microslits are fluidically connected to the aperture at the first membrane surface.
Statement 81. A functionalized silicon membrane (e.g., nanomembrane) according to Statement 79 or Statement 80, where one or more additional apertures extend through the thickness of the silicon substrate such that a corresponding one or more additional membrane surfaces are formed by the one or more aperture.
Statement 82. A functionalized silicon membrane (e.g., nanomembrane) according to any one of Statements 74-81, where the nanomembrane thickness is 20 nm to 10 μm.
Statement 83. A functionalized silicon membrane (e.g., nanomembrane) according to any one of Statements 74-82, further comprising two or more selectively functionalized membrane surfaces, one or more selectively functionalized aperture, one or more selectively functionalized intra-pore or intra-slit surface, or a combination thereof.
Statement 84. A functionalized silicon membrane (e.g., nanomembrane) according to any one of Statements 74-83, where the terminal group is a non-fouling group.
Statement 85. A functionalized silicon membrane (e.g., nanomembrane) according to Statement 84, where the terminal functional group is chosen from sulfobetaine, sulfobetaine analogs and derivatives thereof, Fmoc-lysine, hydroxylamine-O-sulfonic acid, 3-(amidinothio)-1-propanesulfonic acid, 6-carbon to 8-carbon terminal aldehydes with fluorinated alkyl/aliphatic chains (e.g., heavily fluorinated alkyl/aliphatic chains), perfluoro octanesulfonamide, ethanolamine, a peptide, and surface property modifying groups, and combinations thereof.
Statement 86. The functionalized silicon nanomembrane of claim 38, where the surface property modifying group is chosen from linear aliphatic groups, branched aliphatic groups, charged groups, non-polar groups, amphiphilic groups, primary amines, secondary amines, tertiary amines, carboxylates of various carbon chain length, sulfonates of various carbon chain length, canonical amino acids, and non-canonical amino acids.
Statement 87. A functionalized silicon membrane (e.g., nanomembrane) according to any one of Statements 74-86, where the functionalized silicon nanomembrane has a functionalized surface density of 20% to 100% surface coverage extent.
Statement 88. A fluidic device comprising a functionalized silicon nanomembrane according to any one of Statements 74-87.
Statement 89. A fluidic device comprising a functionalized silicon nanomembrane according to any one of Statement 76-88 and further comprising:

a first fluidic channel and/or chamber in fluidic contact with the silicon substrate;

a second fluidic channel and/or chamber in fluid contact with the nanomembrane; and

where the first fluidic channel and/or chamber is in fluidic communication with the second fluidic channel by way of the aperture and the plurality of nanopores, micropores, or microslits of the membrane.
Statement 90. A fluidic device according to Statement 90, where one or more additional apertures extend through the thickness of the silicon substrate, and where the first fluidic channel and/or chamber is further in fluidic communication with the second fluidic channel by way of the one or more additional apertures.
Statement 91. A fluidic device according to any one of Statements 88-90, further comprising a device for performing a filtration.
Statement 92. A method of performing a filtration, comprising:
   a) contacting an input solution with a functionalized silicon nanomembrane, where the input solution contacts a first side a membrane; and
   b) collecting a volume of the input solution that permeates through the membrane, where the volume is collected on a second side of the membrane and/or one or more aperture coupled to the second side of the membrane.
Statement 93. A method according to Statement 92, where contacting the input solution with the first side comprises normal or tangential flow relative to the first side and the flow is gravity flow, hydrostatic pressure, pumping, vacuum, centrifugation, gas pressurization, or a combination thereof.
Statement 94. A method according to Statement 92 or Statement 93, further comprising contacting the second side and/or the one or more aperture with a second solution during collection of the permeating volume of the input solution.
Statement 95. A method according to Statement 94, where the flow of the second solution is parallel with, perpendicular to, or counter to the flow of the input solution.
Statement 96. A method according to Statement 94 or Statement 95, further comprising permeation of one or more solutes from the input solution to the second solution or permeation of the one or more solutes from the second solution to the input solution.
Statement 97. A method according to any one of Statements 92-96, where performing the filtration comprises using one or more fluidic devices according to any one of Statements 88-91.
Statement 98. A method according to any one of Statements 92-97, where the input solution comprises a laboratory, clinical, or industrial solution.
Statement 99. A method according to any one of Statements 94-96, where the second solution comprises a dialysate or buffer and the filtration is a routine separation.
Statement 100. A method according to anyone of Statements 94-96 or 99 where the input solution comprises a laboratory, clinical, or industrial solution, the second solution comprises a dialysate or buffer, and the filtration is a sterile filtration.
Statement 101. A method according to anyone of Statements 94-96,99, or 100, where the input solution comprises blood, the second solution comprises a dialysate, and the filtration is hemodialysis.

The following examples are presented to illustrate the present disclosure. They are not intended to be limiting in any matter.

### EXAMPLE 1

This example provides a description of preparation and characterization of functionalized of silicon nanomembranes of the present disclosure.

Chemistry Deposition System development and testing. This examples describes gaseous phase surface derivatization process for low-stress SiN membrane substrates. Additionally, surface decoration will be monitored by subsequent interaction with reactive species.

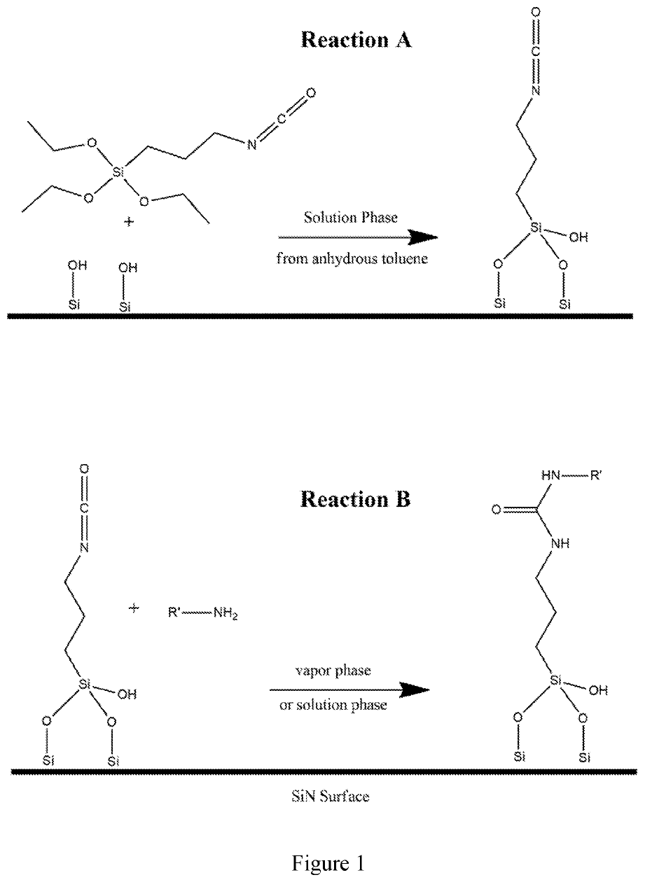

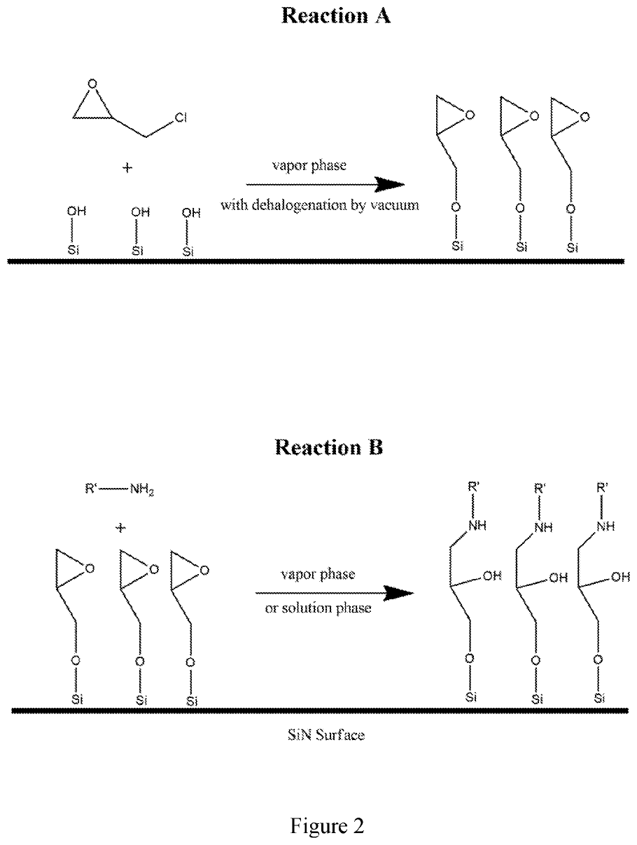

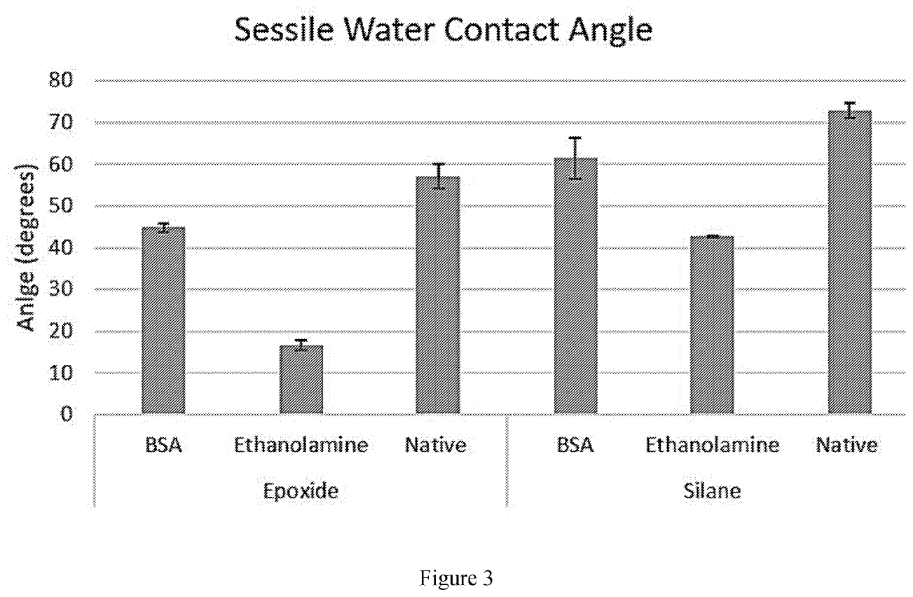

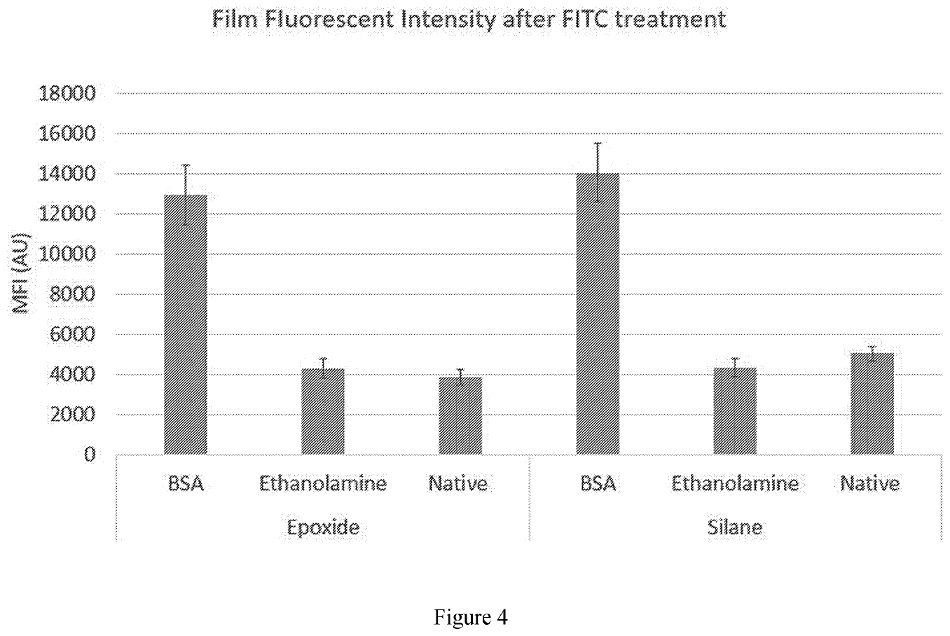

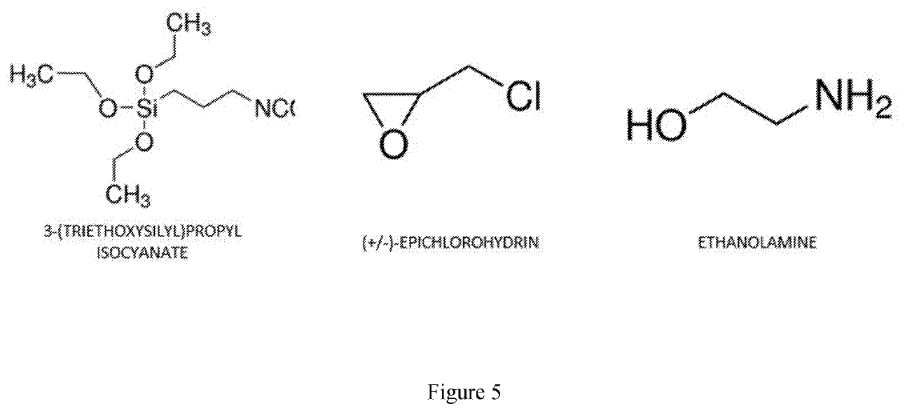

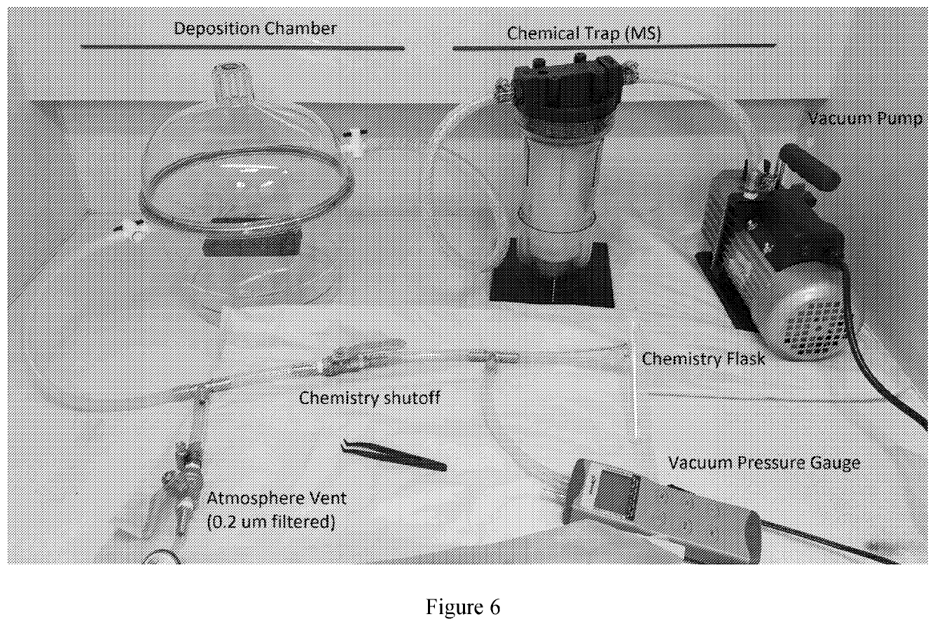

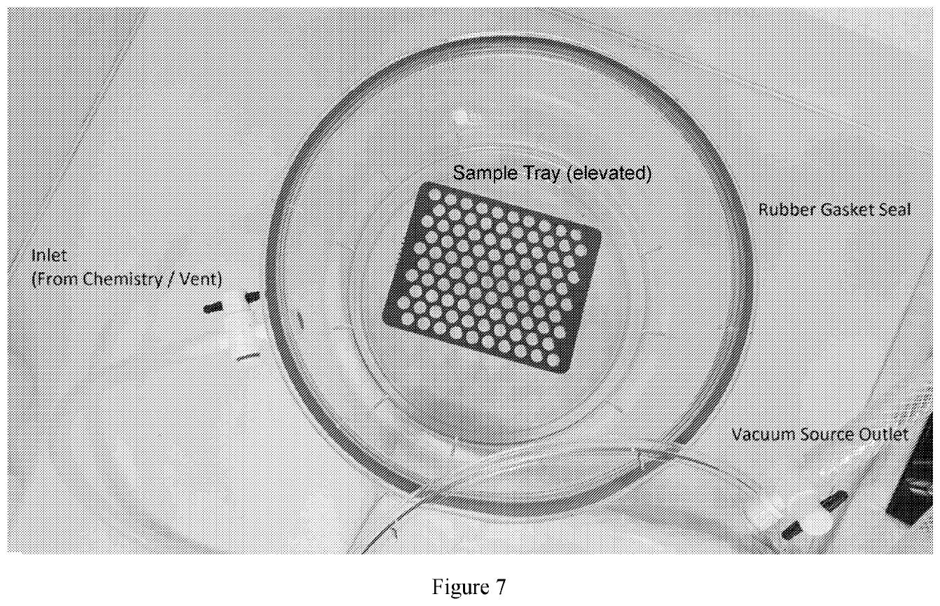

Materials. Chemicals used for surface functionalization included 3-(triethoxysilyl)propyl Isocyanate, (+/−) epichlorohydrin, ethanolamine, toluene (Anhydrous), N-propanol, dimethyl sulfoxide (DMSO), and Fluorescein Isocyanate Isomer 1 were used as received from Sigma Aldrich at ASC grade or better. FIGS. 1 and 2 shows the relevant chemical structures for surface derivatizing schemes explored in this work.

Experiment Setup. A basic vacuum deposition system was fabricated from off-the-shelf components. Images of the system used are attached for reference. Briefly, a vacuum source (mid-range rotary vane pump) is connected via inline vapor trap (pre-loaded with molecular sieves) to a polycarbonate desiccator dome (Nalgene Inc.). Inside the dome was placed a sample holder (entirely polypropylene construction), elevated ˜3″ from the chamber bottom to promote ideal gas flow to the samples. The dome inlet supplies (vie straight wye) either 0.2 micron filtered atmosphere vent or chemistry vapor generated from a borosilicate glass tube (25 mL capacity). Both inlet types are individually controlled via full-port ball valves. A pressure gauge (VWR brand, NIST traceable) is used to monitor system pressure inline to the chemistry flask. After assembly the system was leak checked and is suitable for maintaining a 8 kPa vacuum for at least 24 hours.

Preparation of Substrates. A 4″ SiN coated double-side polished wafer was used as the source material for all experiments. Individual die were cleaved into ˜1 cm² surface are substrates and held in glass dishes until use. All substrates used in deposition experiments were cleaned using a standard Piranha wash (3:1 H₂SO₄:H₂O₂) for 1 hour at RT, then rinsed in excess with nanopure 18.6 MΩ water and used immediately.

Deposition of Epichlorohydrin. Substrates (prepared as above) were placed on the sample holder in the dome, then the system was evacuated of atmosphere to at least 8 kPa. Following which 2 grams of epichlorohydrin was allowed to vaporize from the chemistry flask at RT over a period of 2 hours as follows:
1) Achieve base vacuum pressure
2) Close vacuum source valve
3) Open chemistry valve
4) Wait 1 hour
5) Open vacuum source valve
6) Pump vacuum for 1 hour
7) Purge to atmosphere <10 minutes

During this process all of the liquid chemistry was converted to a vapor at RT conditions. Following deposition substrates were recovered from the sample holder and stored in pre-cleaned glass dishes until use.

Deposition of Isocyanate Silane. A series of substrates were prepared as above and collected in a toluene-cleaned glass dish. To these substrates a solution of 10% 3-(triethoxysilyl)propyl Isocyanate (NCO-silane) in anhydrous toluene was added and allowed to react for 2 hours at room temperate with no agitation. Following deposition sensors were rinsed extensively in the dish with fresh toluene, then transferred to a new toluene-containing dish, further rinsed with 2× fresh toluene fractions, then sonicate for 5 minutes to remove nonspecifically adsorbed silane species. After sonication, the waste toluene was displaced with N-propanol via several successive fraction rinses, then each substrate was rinsed under N-propanol stream and N₂ dried. Substrates were collected in a clean glass dish until use.

Verification of Surface Chemistry Reactivity. To verify the surface reactivity of both epoxide and isocyanate derivatized substrates, solutions of ethanolamine and BSA were prepared and allowed to incubate overnight at RT with 250 RPM agitation. Ethanolamine was deposited from a 100 mM solution containing 50 mM borate pH 9.0 whereas BSA was deposited from a 1% solution in PBS pH 7.4. After deposition both solutions were displaced with a wash buffer containing PBS augmented with 0.05% Tween-20 and 5 mM EDTA pH 7.4 (PBS-ET) for 30 minutes at RT with 250 RPM agitation. After washing substrates were individually rinsed under freshly prepared nanopure water stream and N₂ dried.

Fluorescent labeling of surfaces. As a verification of the presence of BSA on each surface type, the surface-bound BSA was fluorescently labeled for later quantitation. A solution of 200 μg/mL FITC isomer 1 was first prepared as a 6 mg/mL solution in DMSO then diluted into 50 mM sodium borate pH 9.0. This solution was then applied from bulk to all substrates and allowed to react for 2 hours with 250 RPM agitation. Following deposition, substrates were individually rinsed in borate buffer then nanopure water and finally dried under N₂ stream.

Contact angle measurements. Sessile water contact angle measurements were collected in triplicate per sensor substrate via deposition of a 2 μL droplet of freshly prepared 0.2 μm filtered nanopure water, then imaged use a USB camera and MicroCapture Pro. Images were then analyzed further in image J for sessile contact angles and post processed using Microsoft Excel.

Fluorescent Intensity Measurement. Surface fluorescence profiles were collected for all conditions via mounting of substrates onto a black 384-well plate pre-coated with a 300 μm silicone gasket to prevent motion of substrates during plate manipulation. Fluorescent intensity was collected via an 13 multimode plate reader and SoftMax Pro 6.3 using a 16-point per well scan of each well, where each substrate covers ˜2.5 wells, yielding at least 32 points per substrate.

The vacuum deposition system fabricated yielded expected performance given the low-cost vacuum pump utilized. Curiously a ˜8 kPa vacuum was suitable for vaporizing the chemistry used in this work, likely due to partial pressure combined with continual evacuation of the chamber during dehalogenation through the second hour of the reaction. Initial film deposition performance was only monitored using water contact angle, a limitation of this study. The results for this assessment are presented as FIG. 1. As the data shows, native films for both surface functionalities elicited a considerable increase in water contact angle relative to a piranha washed control (<10°, data not shown). Importantly, this increase in hydrophobicity correlates well to the surface terminal groups predicted by the mechanism for both chemistries (‘Reaction A’, in the attached schemas). While it is difficult to survey the packing density using this method alone, further reaction of the films to amine compounds including ethanolamine and serum albumin yielded an expected change in sessile contact angle. In both cases, ethanolamine coated films yield a substantial reduction in hydrophobicity which correlates well to the addition of the terminal oxygen and secondary amine to the surface. Similarly, coupling serum albumin to each surface chemistry reduced the surface hydrophobicity, though not as significantly as one would expect. This is likely due to the unfolding of the protein during desiccation which exposes the more hydrophobic core of the molecule during contact angel analysis.

As further verification of the presence of covalently tethered serum albumin, the free amines of the protein were further decorated with FITC. This process, after analysis, yielded a considerable increase in MFI for the BSA-treated substrates, with no appreciable MFI change for the ethanolamine passivated substrates relative to the native film controls.

These data demonstrate a system and process has been constructed and tested suitable for the vapor-phase functionalization of SiN surfaces by an epoxide terminal species. Additionally, the silylation of low-stress SiN has been demonstrated using a model amine-reactive alkoxy silane. Both films produced demonstrate sufficient density to affect a water contact angle change and are sufficiently reactive to amine containing compounds by measurement via the former.

### EXAMPLE 2

This example provides a description of preparation and characterization of functionalized of silicon nanomembranes of the present disclosure.

Non-fouling demonstration of ethanolamine terminated SiN. The following describes the non-fouling potential of ethanolamine derivatized SiN using an assortment of biofluids.

Methods. SiN Preparation. This Example utilized piranha cleaned SiN for all surface derivations. An overview of the functionalization process is provided below.

Substrate Cleaning. A SiN wafer was cleaved into ˜0.75 cm² substrates, then cleaned via a standard 3:1 piranha recipe for 1 hour at RT. Following cleaning, chips were rinsed in bulk and then individually with freshly prepared 0.2 micron filtered 18.6 mOhm water and then dried under N₂ stream.

Epoxide Functionalization. Using the vacuum deposition system (previously described), cleaned SiN die were transferred to the sample holder, then further dehydrated via a 10 min desiccation at 8 kPa. After which 2 grams of (±)-epichlorohydrin (Sigma 481386) was allowed to vaporize into the desiccator dome with the vacuum source isolated for 60 minutes. Following deposition, the chamber was purged to vacuum and allowed to further desiccate for an additional 60 minutes to promote dehalogenation of the surface-bound epichlorohydrin species.

Ethanolamine Deposition. A 10 mM ethanolamine solution was prepared in pH 9.0 Sodium Borate, then exposed to chips previously epoxide-functionalized for 60 minutes at RT in a toluene-cleaned borosilicate glass dish. Following exposure chips were rinsed with NanoPure water extensively and dried under N₂ stream. Contact angle measurements were conducted throughout each step in the above process to ensure consistency with past deposition results.

Biofluid Exposure. After surface treatment, at least 3 chips were exposed to the following conditions: 1% BSA in PBS pH 7.4; 10% calf serum in PBS pH 7.4; and 100% calf serum.

Exposure was conducted in pre-cleaned glass dishes and occurred at RT for 24 hours using 250 RPM orbital agitation. As controls, piranha-cleaned and native SiN die were exposed to the identical solutions as above. Following exposure, chips were briefly rinsed in PBS, then NanoPure water, and dried under N₂ stream.

Surface Labeling. To visualize non-specifically adsorbed protein species, all chips were labeled using a 1 uM solution of FITC prepared in pH 8.0 sodium borate for 1 hour. Following incubation with the fluorophore, chips were rinsed with NanoPure water and dried under N₂ stream. Dry chips were then collected on a 384-well plate, then read using the well-scan mode of the I3 plated reader at excitation and emission wavelengths for Fluorescein. After which raw MFI was exported to Microsoft Excel for further analysis.

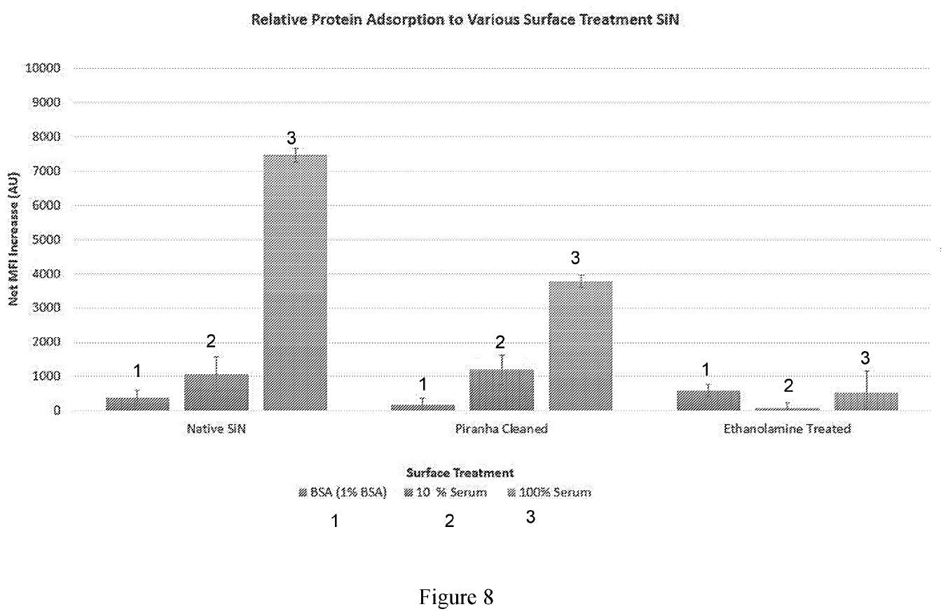

Sessile water contact angle measurements collected through the surface deposition process were consistent with past results for each surface treatment including native SiN (45°±1.8°), piranha cleaned SiN (<5°±2.4°), epichlorohydrin terminated SiN (52°±1.6°), and ethanolamine terminated SiN (22°±2.2°). Surface protein adsorption after 24 hour insult by either purified BSA, dilute serum, or neat serum as monitored by fluorescent labeling by FITC indicated the ethanolamine treatment tends to repel surface fouling for all solutions tested FIG. 8. Note, these data are shown as net MFI relative to non-protein exposed die of each surface treatment type. While results are less compelling for BSA treated surfaces, the ethanolamine treated SiN resists ˜90% protein adsorption from both neat and dilute serum. This effect is likely due to both the hydrophilicity of the surface treatment which forms a strong hydration layer, prohibiting hydrogen bonding to proteins in solution, as well as the near-zero net charge of the film due to the positively charged secondary amines and negatively charged alcohol groups decorating the solvent-accessible surface.

These data demonstrate the resistance of ethanolamine-treated SiN to biofouling using a limited subset of solution types and exposure modalities. Indirectly, the prolonged non-fouling effects of the ethanolamine treated SiN indicates the linker chemistry is reasonably stable under aqueous buffered conditions for at least 24 hours of continual exposure. Further work is necessary to fully characterize both the reproducibility of surface treatment performance as well as robustness in manufacturing technique.

### EXAMPLE 3

This example provides a demonstration of the biofouling reduction (i.e., non-fouling) effects of the surface treatment methods detailed herein.

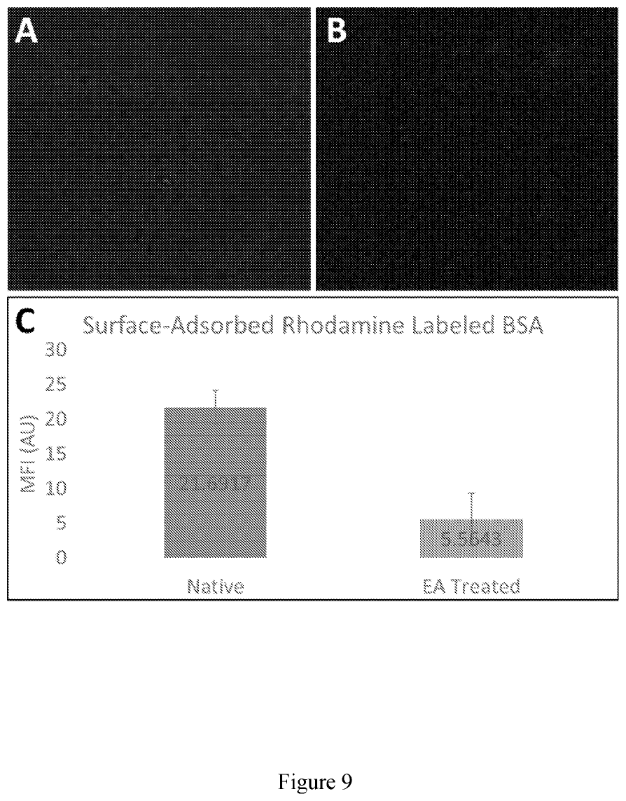

FIG. 9 shows relative surface fouling by a fluorescently labeled bovine serum albumin solution. Image (A) and (B) show fluorescent microscopy (4× magnification) of NPN nanomembrane films untreated and treated with the ethanolamine surface chemistry respectively. Image (C) shows the quantitative whole-field mean fluorescent intensity of both fields shown in (A, B). All data represent the average membrane surface mean fluorescent intensity of a 0.25 mm² surface area and two replicate chips. The data show that the ethanolamine treatment reduce the extent to which protein is able to absorb to silicon nanomembranes.

In this example, fluorescently labeled serum albumin and whole sheep blood are used to insult treated or untreated nanomembrane surfaces. A dialysis experiment was run through a 4-membrane 100 nm chip using a flow cell device with concurrent-tangential flow, pulling volume at a flow rate of 150 μL/min with a peristaltic pump. A 1 mg/mL solution of Rhodamine-conjugated bovine serum albumin was prepared in 0.9% NaCl (saline solution). Two different nanomembrane surface treatment conditions were tested: 1) NPN nanomembrane coated in epichlorohydrin with ethanolamine as described in Example 2; and 2); 3) NPN membrane, left nominally untreated.

Before running the experiment all tubing and each device was primed with saline solution at a flow rate of 1 mL/min for approximately 10 minutes. Once primed, the device supply was changed to a media bottle containing the BSA solution. Rhodamine-BSA solution was recirculated through the device at flow rate of 150 μL/min through the membrane-containing device system. After 1 hour of concurrent flow, the chip was then removed from the system, briefly rinsed with a fraction of PBS and then freshly prepared 18MΩ water and dried under a stream of 0.2 μm filtered nitrogen. The chip was then analyzed via fluorescent microscopy using a Nikon Eclipse TS100 inverted fluorescence microscopy equipped with a standard TRITC filter cube and using 4× magnification. Images of all membrane surfaces were captured using an Amscope MU1203-FL camera system using a consistent gain and exposure settings for all conditions. Images were analyzed in Image J for Mean Fluorescent Intensity.

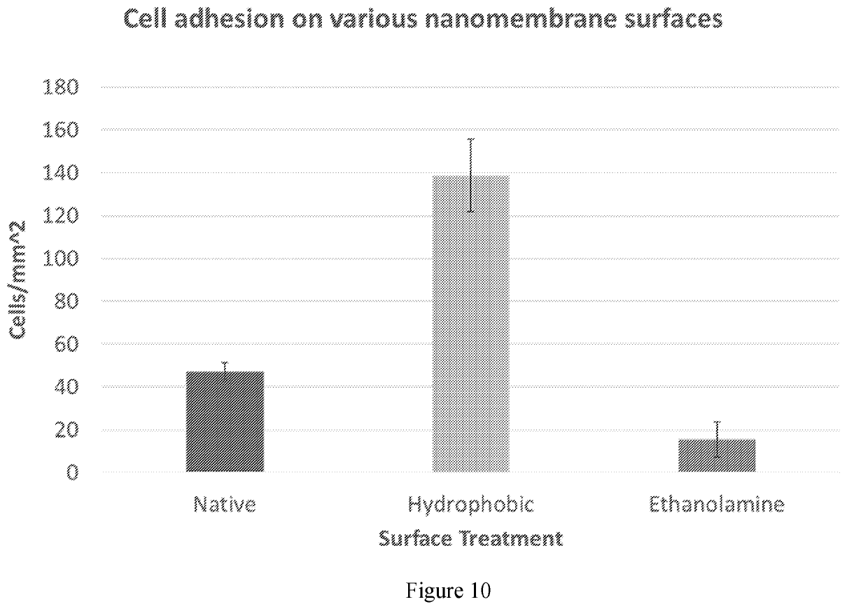

FIG. 10 shows surface adhesion of cells to nanomembrane surfaces of various surface chemistries. These data show a 66% or 89% reduction in cell adhesion for untreated and ethanolamine treated nanomembranes respectively after sheep blood exposure. Moreover, a 67% reduction in cell adhesion was measured for ethanolamine treated nanomembranes relative to untreated (native membranes). All data represents the average of two nanomembranes and triplicate measurements taken for a 0.22 mm² surface area subsection for each membrane.

This second example demonstrated cell adhesion onto three different membrane surface types from whole sheep blood passed over the membrane surface. Using a flow cell device, several 4 slot 100 nm nanomembrane chips were exposed using concurrent-tangential flow in the methods described herein.

Nanomembranes were prepared as follows. Native piranha treated NPN (where the nanomembrane is cleaned with a standard piranha solution after fabrication at the wafer scale, otherwise called a control. NPN coated in epichlorohydrin with ethanolamine (where the nanomembrane is treated as described previously in Example 2). NPN that was rendered hydrophobic by extended exposure to PDMS via passive redeposition at 60° C. for 24 hrs.

Each nanomembrane was installed in a flow cell then fluidically connected to a peristaltic pump and tubing. Before running the experiment, all tubing and the nanomembrane containing flow cell device was primed with saline solution at a flow rate of 1 mL/min for approximately 10 minutes. Once primed, the device input was transferred to heparinized Whole Sheep Blood and the outlet tubing returned to the same media bottle. Sheep Blood was recirculated at a flow rate of 150 μL/min for 1 hour using concurrent flow. Each chip was then removed from the system, briefly rinsed with PBS and dried under a stream of nitrogen. The chip was then analyzed via phase microscopy using a Nikon Eclipse TS100 at 4× magnification/Images were captured using an Amscope MU1203-FL camera system. Following which, images were analyzed via Image-J do detect cells bound to the membrane using particle analysis. This process was repeated for all three conditions.

### EXAMPLE 4

This example provides a description of exemplary fluidic devices and methods for their use in the present disclosure

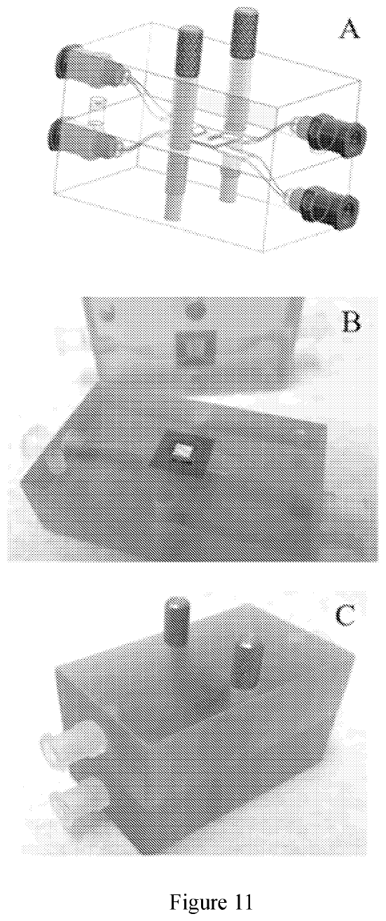

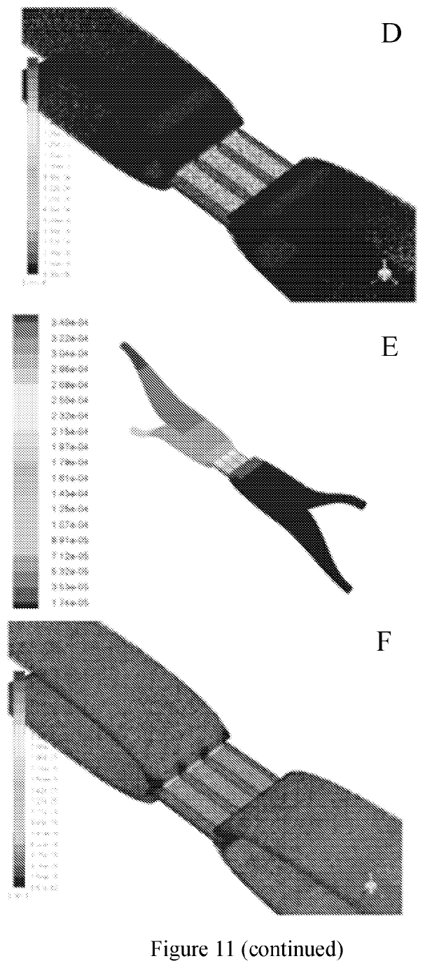

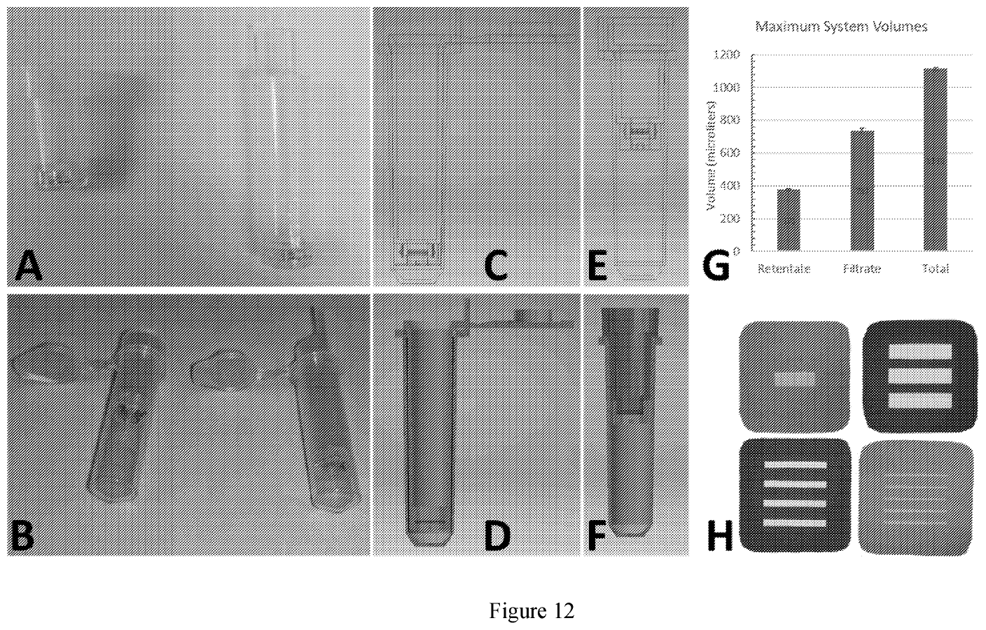

FIGS. 11 and 12 show tangential flow and normal flow, respectively, fluidic devices of the present disclosure incorporating silicon nanomembrane chips.

FIG. 11 shows a tangential flow-based fluidic device for incorporating nanomembrane filters. A prototype Fluidic Module with polycarbonate fluidic channels in the body and elastomeric gaskets for filter integration was fabricated by 3D-printing. CAD modeling software was used to render a prototype device (A) suitable for multi-material 3D-printing (B-C). Computational fluid dynamics analysis was performed on the design to verify surface velocities (D), system pressure (E) and sheer stress (F) to ensure such exemplary prototypes would be suitable fluidic devices for the methods of the present disclosure.

FIG. 12 shows a representative fluidic device incorporating a nanomembrane filter, wherein the nanomembrane filter is integrated into a centrifuge tube insert fluidic device for dead-end (normal) flow filtration purposes. FIG. 12A-F shows representative filter devices incorporating silicon nitride membranes that may employ one or more non-fouling coatings as previously described. (H) shows a series of representative nanomembranes fabricated using similar fabrication processes. As an example, a three-window membrane comprising three 0.7×3 mm suspended membranes, disposed on a silicon substrate of 5.4×5.4 mm and 0.3 mm thickness. The three 0.7×3 mm silicon nitride membranes further comprise a plurality of 8×50 μm openings patterned and etched through the 400 nm thick silicon nitride membranes. Conventional photolithography, reactive ion etching, and wet chemistry through-wafer etching were used to fabricate such microslit filters.

### EXAMPLE 5

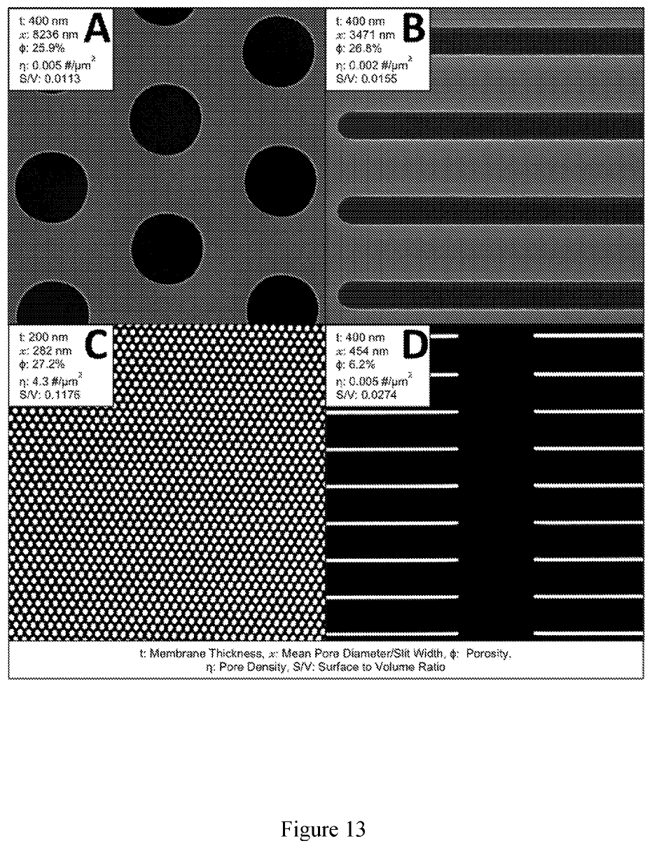

FIGS. 13, 14, and 15 show various examples of silicon nanomembranes of the present disclosure as imaged by electron microscopy and further provide summaries of the physical properties of such exemplary silicon nanomembranes.

FIG. 13 shows images taken via Electron Microscopy of a range of Silicon Nitride membranes. (A) shows a 400 nm thick microporous SiN membrane of 25.9% porosity decorated with 8.2-micron diameter pores at regular intervals. (B) shows a 400 nm thick microslit membrane of 26.8% porosity with 3.5-micron wide slits. (C) shows a 200 nm thick SiN membrane of 27.2% porosity and 282 nm pores at regular intervals. Finally, (D) shows a 400 nm SiN membrane of 6.2% porosity comprised of 454 nm wide slits.

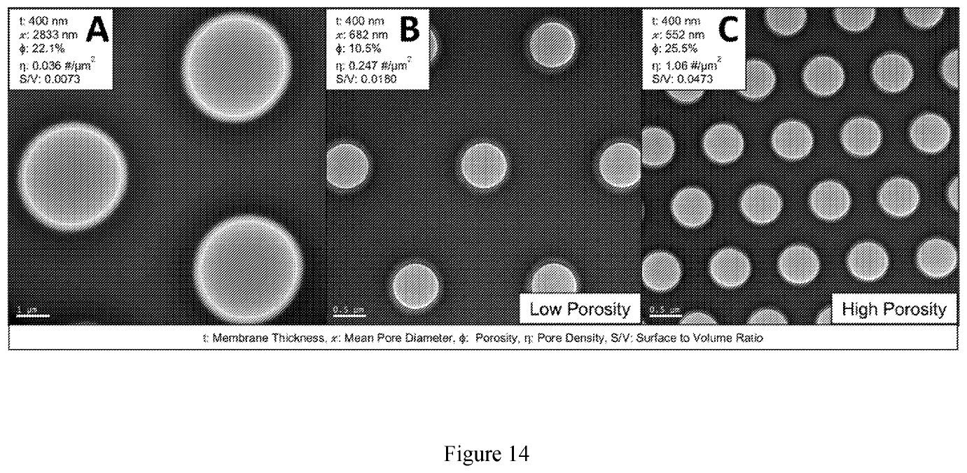

FIG. 14 shows a further image study of micropores as evaluated by electron microscopy. (A) Shows a 400 nm thick SiN membrane of 22.1% porosity containing 2.8-micron diameter pores. (B) Shows a 400 nm thick SiN membrane of 10.5% porosity containing 682 nm diameter pores. (C) Shows a 400 nm thick SiN membrane of 25.5% porosity containing 552 nm diameter pores.

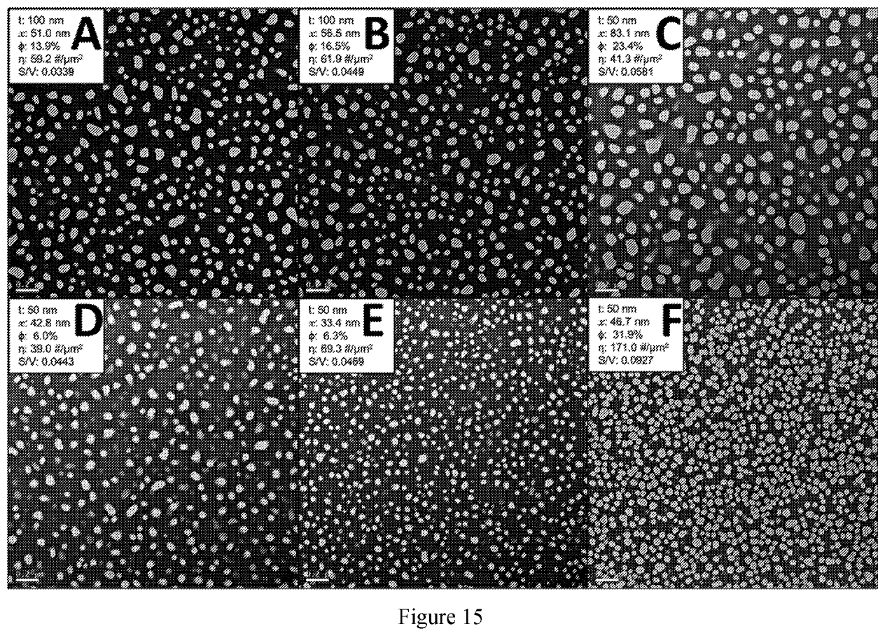

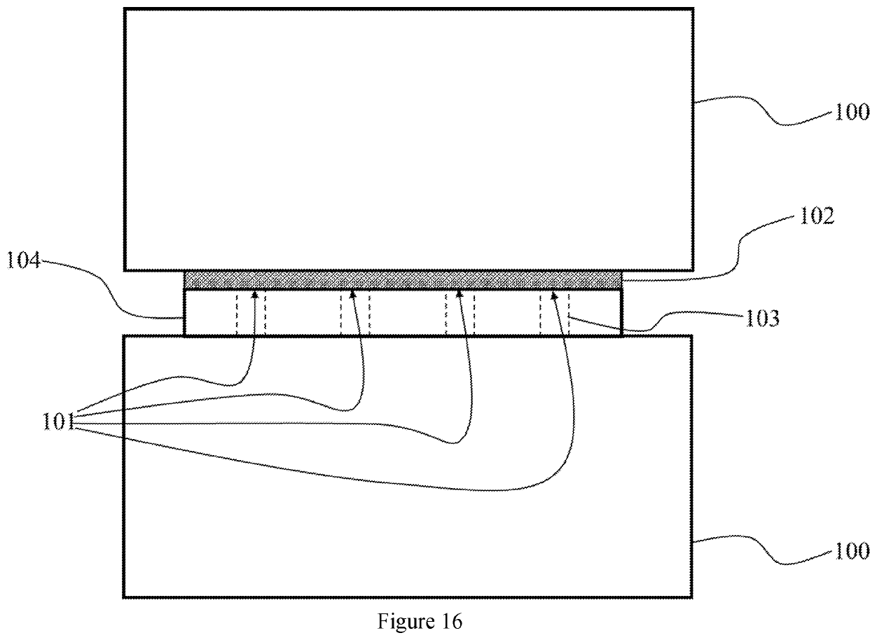

FIG. 15 shows a series of nanoporous nitride membranes fabricated using a range of membrane thicknesses, pore diameters, and porosities. (A, B) show a series of 100 nm thick membranes decorated with either 51 nm pores and 13.9% porosity, or 56.5 nm pores and 16.5% porosity respectively. Images (C-F) show a series of nanomembranes of 50 nm nominal thickness decorated with a range of pore diameters and porosities as follows [C; 83 nm pores, 23.4% porosity. D; 42.8 nm pores, 6% porosity. E; 33.4 nm pores, 6.3% porosity. F; 46.7 nm pores, 31.9% porosity].

Although the disclosed subject matter will be described in terms of certain embodiments/examples, other embodiments/examples, including embodiments/examples that do not provide all of the benefits and features set forth herein, are also within the scope of the present disclosure.

1. A method for functionalizing a silicon nanomembrane comprising:
a) contacting a nanomembrane with one or more chemical oxidant;
b) contacting the nanomembrane with one or more epihalohydrin molecules;
c) contacting the nanomembrane with one or more acid or base catalyst; and
d) contacting the nanomembrane with one or more terminal group forming compounds.

2. The method of claim 1, wherein the chemical oxidant comprises a solution of hydrogen peroxide and sulfuric acid or ammonium hydroxide and hydrogen peroxide.

3. The method of claim 1, wherein the one or more epihalohydrin is gaseous and chosen from epichlorohydrin and epibromohydrin.

4. The method of claim 3, wherein the one or more gaseous epihalohydrin has a vapor pressure of 1.3 to 2666.6 Pascal.

5. The method of claim 1, wherein the one or more acid or base catalyst comprises a Lewis acid or Lewis base, respectively.

6. The method of claim 1, wherein the one or more terminal group forming compound is an amine-containing molecule in either gas-phase or solution-phase, wherein such terminal groups comprise non-fouling or surface property modifying groups, or a combination thereof.

7. The method of claim 1, further comprising contacting the nanomembrane with one or more spacer forming molecule prior to contacting the nanomembrane with one or more solution-phase or gas-phase terminal group forming compound, wherein the spacer molecule comprises one or more amine group, an aliphatic chain of two or more carbons, and one or more second reactive group.

8. A method for functionalizing a silicon nanomembrane comprising:
a) contacting a nanomembrane with one or more chemical oxidant;
b) contacting the nanomembrane with one or more aldehyde;
c) contacting the nanomembrane with one or more reductive amination agents; and
d) optionally, contacting the nanomembrane with one or more terminal group forming compound.

9. The method of claim 8, wherein the chemical oxide etchant comprises an aqueous solution of hydrofluoric acid or ammonium fluoride and hydrofluoric acid.

10. The method of claim 8, wherein the one or more aldehyde is gaseous and has a vapor pressure of 1.3 to 2666.3 Pascal.

11. The method of claim 8, wherein the one or more aldehyde comprises a solution of 1 μM to 10 M total aldehyde.

12. The method of claim 8, further comprising using a dehydrating agent.

13. The method of claim 8, wherein the one or more solution-phase reductive amination agent comprises an aqueous solution of sodium borohydride, sodium cyanoborohydride, sodium triacetoxyborohydride, or a combination thereof.

14. The method of claim 8, wherein an aldehyde of the one or more aldehyde comprises one or more aldehyde functional group, one or more aliphatic chain length of three or more carbons, and at least one terminal group.

15. The method of claim 8, wherein an aldehyde of the one or more aldehyde comprises at least two aldehyde groups and an aliphatic chain length of three or more carbons.

16. The method of claim 8, wherein the terminal groups comprise non-fouling or surface property modifying groups, or a combination thereof.

17. The method of claim 8, further comprising contacting the membrane with one or more silane between c) and d).

18. The method of claim 17, wherein the chemical oxide etchant comprises an aqueous solution of hydrofluoric acid or ammonium fluoride and hydrofluoric acid, the reductive amination agent comprises an aqueous solution of sodium borohydride, sodium cyanoborohydride, sodium triacetoxyborohydride, or a combination thereof, and the one or more aldehyde comprises one or more aldehyde group, one or more aliphatic group of three or more carbons, and at least one terminal group or at least two aldehyde groups and an aliphatic group of three or more carbons.

19. The method of claim 17, wherein the one or more silane is gaseous and has a vapor pressure of 1.3 to 2666.5 Pascal.

20. The method of claim 17, wherein the one or more silane comprises a solution of 1 μm to 1 mM total silane.

21. The method of claim 17, wherein the one or more silane comprises one or more silane functional group, one or more aliphatic group of three or more carbons, and one or more terminal group.

22. The method of claim 17, wherein the one or more silane comprises one or more silane functional group, one or more reactive or leaving group, at least one aliphatic group of three or more carbons.

23. The method of claim 17, wherein the terminal groups comprise non-fouling or surface property modifying groups, or a combination thereof.

24. The method of claim 17, wherein the molecular sizes of the aldehydes and silanes are specified relative to each other, such that neither sterically hinders the derivatization of substrate surface groups.

25. The method of claim 17, further comprising cross-linking any of the functional groups disposed on a membrane surface.

26. The method of claim 8, further comprising selective functionalization of a plurality of membrane surfaces, one or more aperture, or one or more intra-pore or intra-slit surface, or a combination thereof.

27. A functionalized silicon nanomembrane, wherein the silicon nanomembrane is chosen from a nanoporous silicon nitride membrane, a microporous silicon nitride membrane, a microslit silicon nitride membrane, and a microporous silicon oxide membrane.

28. The functionalized silicon nanomembrane of claim 27, wherein the functionalization comprises at least one dimension that is less than 20% of mean pore diameter or microslit width.

29. The functionalized silicon nanomembrane of claim 27, further comprising a plurality of surfaces and a plurality of nanopores, micropores, or microslits passing therebetween.

30. The functionalized silicon nanomembrane of claim 27, wherein the functionalized silicon nanomembrane has a nanopore or micropore diameter, or a microslit width of 11 nm to 10 μm.

31. The functionalized silicon nanomembrane of claim 27, wherein the nanomembranes have a nanopore, a micropore, or a microslit density of 10² to 10¹⁰ pores/mm².

32. The functionalized silicon nanomembrane of claim 27, further comprising a silicon substrate of <100> or <110> crystal orientation, and wherein the nanomembrane is disposed on the silicon substrate.

33. The functionalized silicon nanomembrane of claim 32, wherein an aperture extends through the thickness of the silicon substrate such that a first membrane surface is formed by the aperture, and at least some of the plurality of nanopores, micropores, or microslits are fluidically connected to the aperture at the first membrane surface.

34. The functionalized silicon nanomembrane of claim 33, wherein one or more additional apertures extend through the thickness of the silicon substrate such that a corresponding one or more additional membrane surfaces are formed by the one or more aperture.

35. The functionalized silicon nanomembrane of claim 27, wherein the nanomembrane thickness is 20 nm to 10 μm.

36. The functionalized silicon nanomembrane of claim 27, further comprising two or more selectively functionalized membrane surfaces, one or more selectively functionalized aperture, one or more selectively functionalized intra-pore or intra-slit surface, or a combination thereof.

37. The functionalized silicon nanomembrane of claim 27, wherein the terminal group is a non-fouling group.

38. The functionalized silicon nanomembrane of claim 36, wherein the terminal functional group is chosen from sulfobetaine, sulfobetaine analogs and derivatives thereof, Fmoc-lysine, hydroxylamine-O-sulfonic acid, 3-(amidinothio)-1-propanesulfonic acid, 6-carbon to 8-carbon terminal aldehydes with heavily fluorinated alkyl/aliphatic chains, perfluoro octanesulfonamide, ethanolamine, a peptide, and surface property modifying groups, and combinations thereof.

39. The functionalized silicon nanomembrane of claim 38, wherein the surface property modifying group is chosen from linear aliphatic groups, branched aliphatic groups, charged groups, non-polar groups, amphiphilic groups, primary amines, secondary amines, tertiary amines, carboxylates of various carbon chain length, sulfonates of various carbon chain length, canonical amino acids, and non-canonical amino acids.

40. The functionalized silicon nanomembrane of claim 27, wherein the functionalized silicon nanomembrane has a functionalized surface density of 20% to 100% surface coverage extent.

41. A fluidic device comprising a functionalized silicon nanomembrane of claim 27.

42. A fluidic device comprising a functionalized silicon nanomembrane of claim 32 and further comprising:
a first fluidic channel and/or chamber in fluidic contact with the silicon substrate;
a second fluidic channel and/or chamber in fluid contact with the nanomembrane; and
wherein the first fluidic channel and/or chamber is in fluidic communication with the second fluidic channel and/or chamber by way of the aperture and the plurality of nanopores, micropores, or microslits of the nanomembrane.

43. The fluidic device of claim 42, wherein one or more additional apertures extend through the thickness of the silicon substrate, and wherein the first fluidic channel and/or chamber is further in fluidic communication with the second fluidic channel and/or chamber by way of the one or more additional apertures.

44. The fluidic device of claim 41, further comprising a device for performing a filtration.

45. A method of performing a filtration, comprising:
a) contacting an input solution with a functionalized silicon nanomembrane, wherein the input solution contacts a first side a membrane; and
b) collecting a volume of the input solution that permeates through the membrane, wherein the volume is collected on a second side of the membrane and/or one or more aperture coupled to the second side of the membrane.

46. The method of claim 45, wherein contacting the input solution with the first side comprises normal or tangential flow relative to the first side and the flow is gravity flow, hydrostatic pressure, pumping, vacuum, centrifugation, gas pressurization, or a combination thereof.

47. The method of claim 45, further comprising contacting the second side and/or the one or more aperture with a second solution during collection of the permeating volume of the input solution.

48. The method of claim 47, wherein the flow of the second solution is parallel with, perpendicular to, or counter to the flow of the input solution.

49. The method of claim 47, further comprising permeation of one or more solutes from the input solution to the second solution or permeation of the one or more solutes from the second solution to the input solution.

50. The method of claim 45, wherein performing the filtration comprises using one or more fluidic devices of claim 41.

51. The method of claim 45, wherein the input solution comprises a laboratory, clinical, or industrial solution.

52. The method of claim 47, wherein the second solution comprises a dialysate or buffer and the filtration is a routine separation.

53. The method of claim 47, wherein the input solution comprises a laboratory, clinical, or industrial solution, the second solution comprises a dialysate or buffer, and the filtration is a sterile filtration.

54. The method of claim 47, wherein the input solution comprises blood, the second solution comprises a dialysate, and the filtration is hemodialysis.
